(19) United States
(12) Patent Application Publication
(10) Pub. No.: US 2026/0310746 A1
(43) Pub. Date: Oct. 8, 2026

(54) COMPUTING SYSTEM AND METHOD FOR SOLVING DIFFERENTIAL EQUATIONS

(71) Applicants: Phinyx AI Inc., Providence, RI (US); Brown University, Providence, RI (US)

(72) Inventors: Adar Kahana, Swansea, MA (US); George Em Karniadakis, Newton, MA (US); Jerome Bernard Darbon, Providence, RI (US)

(21) Appl. No.: 19/641,888

(22) Filed: Apr. 8, 2026

Related U.S. Application Data
(60) Provisional application No. 63/785,155, filed on Apr. 8, 2025.

(51) Int. Cl. G06F 17/13; G06F 30/27; G06F 111/06

(52) U.S. Cl. CPC G06F 17/13; G06F 30/27; G06F 2111/06

(57) ABSTRACT

A computing system and method for solving differential equations. An example computing system may include a server system configured to receive, from a computing device deployed within the communication network, a query to a large language model (LLM) for solving a problem; formulate a differential equation in connection with the problem; discretize the differential equation with a selected method; select a plurality of combinations of neural operators and relaxation methods to form a Pareto front of viable solutions to the problem; dynamically construct an array of meta-solvers based on the selected combinations of neural operators and relaxation methods; identify a meta-solver from the array of meta-solvers to best solve the problem based on selected criteria; use the meta-solver to generate problem solutions; and display the problem solutions to the computing device.

### PRIORITY CLAIM

This application claims priority to and the benefit as a non-provisional application of U.S. Provisional Patent Application No. 63/785,155, filed Apr. 8, 2025, the entire contents of which are hereby incorporated by reference and relied upon.

### FIELD OF TECHNOLOGY

The present disclosure generally relates to solving differential equations, and more particularly relates to a machine learning (ML) based computing system and method configured to determine which equations should be combined together to solve a physical or engineering problem for a linear or nonlinear discrete system.

### BACKGROUND

Since the proposal of numerical methods for solving differential equations more than half a century ago, scientists and engineers have been able to significantly expand knowledge and insights that have never been achieved in the analytical era, in all fields of physical sciences and engineering such as astrophysics, quantum physics, fluid dynamics, solid mechanics, material science, and electrodynamics. With an appropriate numerical method such as finite differences, finite elements, or a spectral method, one may obtain a solution of differential equations that may involve nonlinearity, complex geometry, and/or multiscale phenomena. Thus, one acquires a quantitative knowledge and understanding of the governing mechanism of physical and engineering systems.

Despite the diversity of differential equations in different areas, their numerical solutions, in many cases, are reduced to solving systems of linear equations as the last step. This seemingly simple task remains unresolved in many practical applications. Existing numerical solvers are frequently convergent and stable only for linear systems satisfying certain conditions (e.g., positive definiteness). Computational efficiency becomes an issue when dealing with large-scale systems. Among the iterative solvers, the Jacobi method and the Gauss-Seidel method, as the most classical methods, suffer from divergence for non-symmetric and indefinite systems and slow convergence associated with low-frequency eigenmodes. More advanced iterative methods and techniques have been proposed to mitigate these two issues. In particular, multigrid methods use a hierarchy of discretizations to efficiently relax eigenmodes of all frequencies, making them one of the state-of-the-art methods in terms of computational efficiency. Despite being a century-old problem, solving linear systems is still an open question, calling for better algorithms that are more efficient and applicable to broader classes of linear systems.

In the recent decade, scientific machine learning (SciML) has developed rapidly for problems in physical sciences and engineering due to its potential advantage in predictive capability and efficiency. In particular, deep learning for operator regression is an active research area of wide interest for system identification and fast inference. Recent works have proposed several frameworks, including the deep operator network (DeepONet), Fourier Neural Operator (FNO), etc. Among these methods, DeepONet was the original method and was proposed based on the universal approximation theorem for operators, showing a strong prediction capability in diverse engineering fields. It provides fast inference for mappings between functions, which can be highly nonlinear and may take hours or even days to simulate using traditional approaches.

In some SciML works, researchers introduce learning algorithms into numerical solvers for differential equations and/or their associated linear systems. Briefly, these works seek to replace and/or improve existing numerical solvers. Physics-informed neural networks and related works represent a unique methodology where the differential equation is explicitly encoded into the loss function, hence entirely eliminating the need to employ numerical solvers during both training and testing stages. Among the majority of studies without such explicit encoding, a deep learning model needs to be trained with sufficient data, typically acquired from simulated data, experimental measurements, or a combination of both. Once the training completes, it provides fast and approximate predictions without invoking numerical solvers. Several other studies focus on improvements on top of numerical solvers, such as: a correction on coarse-grid results, a better iterative scheme, a better initial guess of the solution, a better meshing strategy, a better discretization operator, a better prolongator/restrictor or a preconditioner for multigrid methods.

Accordingly, there is a need for a ML-based computing system and method that integrates different neural operators with standard relaxation methods to generate a hybrid, iterative, numerical, and transferable solver for differential equations.

### SUMMARY

The present disclosure relates to a hybrid, iterative numerical solver framework referred to as HINTS (Hybrid, Iterative, Numerical, and Transferable Solver). HINTS is a computing system and method for solving differential equations, in particular those that give rise to large-scale linear systems, by integrating one or more trained neural operators with one or more classical iterative relaxation solvers. Rather than replacing established numerical solvers, HINTS embeds neural operator inference into a conventional iterative solution process, thereby forming a unified solver architecture that is compatible with existing discretization schemes, solver infrastructures, and high-performance computing environments.

Numerical solution of differential equations frequently reduces to solving large, sparse linear systems whose convergence behavior depends strongly on spectral properties of the underlying operator. Classical iterative solvers, such as Jacobi, Gauss-Seidel, or multigrid smoothers, are efficient in reducing high-frequency error components but often converge slowly, or even diverge, when low-frequency or near-null-space error components dominate, particularly for indefinite or highly heterogeneous problems. Existing machine-learning-based solvers, while capable of fast approximate inference, generally lack robustness, consistency, and guaranteed convergence. The present disclosure addresses this long-standing challenge by providing a solver framework that achieves fast, stable, and scalable convergence of numerical solutions across a broad class of differential equations and discretizations.

In operation, HINTS executes an iterative correction process in which an approximate solution is successively updated based on a computed residual. At selected iterations, determined for example by a fixed or adaptive ratio parameter, a trained neural operator is invoked to compute a correction corresponding to the current residual, while at other iterations a classical relaxation method is applied. The neural operator receives problem data, such as residuals and coefficient fields, and produces a correction targeting components of the solution that are poorly handled by the numerical solver alone. This alternating or interleaved architecture may be realized within a single-level iterative method or embedded as a component of a multilevel or preconditioned solver, and may be applied independently of the discretization resolution used during neural-operator training.

The performance advantages of HINTS arise from spectrally complementary error reduction. Neural operators exhibit a spectral bias that enables efficient approximation of low-frequency or slowly varying components of solution error, which are known to impede convergence of classical iterative solvers. In contrast, relaxation-based solvers efficiently damp high-frequency error components and provide numerical stability guarantees. By combining these complementary behaviors within a single iterative scheme, HINTS achieves uniform and accelerated convergence across the full error spectrum, mitigates divergence in otherwise unstable problems, and preserves convergence to machine precision. Importantly, this improvement is obtained without sacrificing the robustness, determinism, and scalability of traditional numerical solvers.

Embodiments of the present disclosure include: (i) an iterative solver that alternates between a neural-operator-based correction step and a classical relaxation step, (ii) residual-driven invocation of the neural operator, and (iii) use of the hybrid solver as either a standalone iterative method or as a component of a preconditioned or multilevel solver. Optional and extensible embodiments include, but are not limited to, use of different neural-operator architectures, integration within Krylov subspace methods, automatic selection or tuning of solver parameters via optimization techniques, application to nonlinear or time-dependent problems, and automated generation or selection of solver configurations using generative artificial intelligence. These optional features enhance applicability and automation but are not required for the fundamental operation or advantages of HINTS.

The disclosed HINTS framework accordingly produces a concrete technical effect in the field of numerical computing by measurably improving the convergence, stability, and scalability of computer-implemented solvers for differential equations. By embedding neural-operator-based residual corrections into an iterative numerical solver, the system alters the spectral error dynamics of the underlying computation, suppressing low-frequency error components that otherwise cause slow convergence or divergence in conventional iterative methods, while preserving reliable high-frequency error damping by classical solvers. This hybrid architecture reduces the number of required iterations, enables convergence for otherwise unstable indefinite systems, and improves computational efficiency for large-scale problems executed on parallel computing hardware. The improvement arises from a specific interaction between trained neural operators and numerical relaxation algorithms during execution of the solver, rather than from abstract mathematical manipulation or result interpretation. As such, the invention provides a technical solution to a technical problem in scientific computing by controlling how a computer performs iterative numerical calculations, yielding demonstrable performance and robustness gains over prior solver implementations.

In one aspect, the present disclosure provides a computing system for dynamically constructing an array of meta-solvers for solving a differential equation. Based on received problem data defining the differential equation and associated numerical characteristics, the system identifies multiple candidate neural operators and multiple candidate relaxation-based numerical solvers. The system then dynamically generates a plurality of meta-solvers, each meta-solver comprising a selected combination of a neural operator and a relaxation method together with an execution schedule that governs how the two components are applied during an iterative solution process.

In particular embodiments, each constructed meta-solver employs an execution schedule that alternates neural-operator-based correction steps with relaxation-based numerical solver steps, using either a fixed or adaptive ratio. The neural operator is invoked intermittently during the iterative process to target error components that are inefficiently reduced by the relaxation method alone, thereby complementing the numerical solver rather than replacing it. This alternating architecture enables stable and accelerated convergence while preserving the numerical robustness of classical iterative methods.

In some embodiments, the meta-solvers operate on residual data generated during iterative execution of a discretized system. The system converts residuals into a representation suitable for neural-operator inference, applies the neural operator to generate a correction, and applies the correction to an approximate numerical solution. By driving neural-operator invocation using residual information arising from the numerical solver itself, the hybrid meta-solver modifies the evolution of error components during execution of the solver, resulting in improved convergence behavior of the computed solution.

In further embodiments, one or more dynamically constructed meta-solvers are configured to operate as preconditioners or subspace solvers for higher-level iterative frameworks, including Krylov subspace methods or multilevel solvers. In such configurations, the alternating application of the neural operator and relaxation method accelerates convergence of the outer solver by suppressing error components that would otherwise impede progress, including low-frequency or near-null-space components that cause stagnation or divergence in conventional approaches.

In some implementations, dynamically constructing the array of meta-solvers comprises generating multiple solver configurations that differ in at least one of the neural-operator architecture, the relaxation method, or the execution schedule governing neural-operator invocation. The system evaluates the generated meta-solvers using one or more performance metrics and selects an optimal meta-solver for application to the problem. Optional embodiments may further include integrating the selected meta-solver into existing solver infrastructures or automatically refining solver configurations; however, the dynamic construction of hybrid meta-solvers from combinations of neural operators and relaxation methods constitutes the core functionality of the disclosed system.

The advantages discussed herein may be found in one, or some, and perhaps not all of the embodiments disclosed herein. Additional features and advantages are described herein, and will be apparent from, the following Detailed Description and the figures.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a diagram of a ML-based computing system deployed within a server-based computing environment and communication network, according to an exemplary aspect of the present disclosure.

FIG. 2 illustrates a block diagram of an example workflow of how to determine an optimal solver using the ML-based computing system of FIG. 1, according to an exemplary aspect of the present disclosure.

FIG. 3 is an overview of a hybrid, iterative, numerical, and transferable solver (HINTS), according to an exemplary aspect of the present disclosure.

FIG. 4(A) illustrates profiles of k(x) and ƒ(x) of a 1D Poisson equation, according to an exemplary aspect of the present disclosure.

FIG. 4(B) illustrates profiles of typical eigenmodes

$${∅}_{i}^{h}$$

(Øᵢ(x); i∈{1, 5, 10} of the solution u(x) and corresponding loading vectors

$$( \frac{{A}^{h} {∅}_{i}^{h}}{‖ {A}^{h} {∅}_{i}^{h} ‖} )$$

of a 1D Poisson equation, according to an exemplary aspect of the present disclosure.

FIG. 4(C) illustrates key snapshots of an approximate solution and norms of residual and error of the approximate solution of a 1D Poisson equation, according to an exemplary aspect of the present disclosure.

FIG. 5(A) illustrates profiles of k(x) and ƒ(x) of a 1D Helmholtz Equation, according to an exemplary aspect of the present disclosure.

FIG. 5(B) illustrates profiles of typical eigenmodes

$${∅}_{i}^{h}$$

(Øᵢ(x); i∈{1, 5, 10} of the solution u(x) and corresponding loading vectors

$$( \frac{{A}^{h} {∅}_{i}^{h}}{‖ {A}^{h} {∅}_{i}^{h} ‖} )$$

of a 1D Helmholtz equation, according to an exemplary aspect of the present disclosure.

FIG. 5(C) illustrates key snapshots of an approximate solution and norms of residual and error of the approximate solution of a 1D Helmholtz equation, according to an exemplary aspect of the present disclosure.

FIG. 6(A) illustrates results of a 2D Poisson equation generated by a HINTS-Jacobi method, according to an exemplary aspect of the present disclosure.

FIG. 6(B) illustrates results of a 3D Helmholtz equation generated by a HINTS-Jacobi method, according to an exemplary aspect of the present disclosure.

FIG. 7(A) illustrates results of a 1D Poisson equation generated by a HINTS-MG method, according to an exemplary aspect of the present disclosure.

FIG. 7(B) illustrates results of a 2D Helmholtz equation generated by a HINTS-MG method, according to an exemplary aspect of the present disclosure.

FIG. 8(A) illustrates results of a large-scale 3D Helmholtz equation solved by F-GMRES, according to an exemplary aspect of the present disclosure.

FIG. 8(B) illustrates convergence behavior and computational time of the F-GMRES method preconditioned with HINTS-MG and AMG, according to an exemplary aspect of the present disclosure.

FIG. 9 illustrates results for a 3D Helmholtz problem, scattering around a submarine where a top line represents Jacobi method, and a bottom line represents a combination of Jacobi and DeepONet, according to an exemplary aspect of the present disclosure.

FIG. 10 illustrates a convergence of a conjugate gradient algorithm, according to an exemplary aspect of the present disclosure.

FIG. 11(A) illustrates a Pareto front and three meta-solvers with parameters p1, p2 and p3, according to an exemplary aspect of the present disclosure.

FIG. 11(B) illustrates convexification of a Pareto front when a scalarization technique is used for non-convex metrics, according to an exemplary aspect of the present disclosure.

### DETAILED DESCRIPTION

Various aspects of the present disclosure will be described with reference to the drawings, wherein like reference numerals are used to refer to like elements throughout. In the following description, for purposes of explanation, numerous specific details are set forth in order to promote a thorough understanding of one or more aspects of the present disclosure. It may be evident in some or all instances, however, that any aspects described below can be practiced without adopting the specific design details described below.

Solving partial differential equations (PDEs) involves a discretization technique, which leads to solving a linear or nonlinear discrete system of equations. Finding fast and accurate methods for this task, especially at scale with over one billion unknowns for industrial problems, is a long-standing challenge in scientific computing. The need for an effective solution strategy becomes even more prevalent in multi-query applications, like uncertainty quantification or in control problems, where the underlying PDE must be solved repeatedly for different parameters, e.g., different material properties, excitation terms, or boundary conditions.

Among other features, the present disclosure relates to an optimal meta-solver via generative artificial intelligence (AI) to accelerate discovery of the next generation of fast solvers by synthesizing meta-solvers without the tyranny of mesh generation and coarsening or the manual programming of millions of lines of code. Specifically, mesh generation is a crucial step in many existing numerical methods for solving PDEs. It involves dividing the computational domain (the area or volume over which the PDE is defined) into smaller, simpler subregions or elements, typically called “cells” or “elements.” This division is called a mesh or grid. The PDE may be solved numerically on this mesh, approximating the solution at discrete points within each element. Numerical methods like the finite element method (FEM), finite difference method (FDM), and finite volume method (FVM) rely on meshes to discretize the domain and approximate the continuous equations with algebraic ones. The quality of the mesh (e.g., element shape, size, and distribution) has a significant impact on the accuracy of the numerical solution. A poorly generated mesh may lead to numerical errors, inaccurate solutions, or even instability in the solver.

Coarsening, on the other hand, is a process of reducing the number of elements or grid points in a mesh or grid, while still trying to preserve the essential features of the solution. It is a critical part of multilevel or multigrid methods and adaptive mesh refinement (AMR), where both refinement (making the mesh finer) and coarsening (making the mesh coarser) are used to optimize computational efficiency and maintain solution accuracy. Coarsening helps reduce the computational cost by using fewer elements or grid points in regions where high resolution is unnecessary, i.e., where the solution is smooth or does not change rapidly. Coarsening is a fundamental part of multigrid methods used to speed up the convergence of PDE solvers. In these methods, the solution is transferred between finer and coarser grids to accelerate the solution process. Coarsening can lead to loss of accuracy if applied too aggressively in regions where the solution changes rapidly. Careful monitoring and adaptive strategies are required to ensure that important features of the solution are captured. In some cases, generating a proper coarser mesh that adequately represents the geometry and boundary conditions of the problem can be difficult.

The disclosed computing system and method exploit the fundamental spectral properties of neural networks and traditional solvers to search for the optimal meta-solver on-demand for a physical, engineering, or finance problem across different applications. Neural networks may suffer from spectral bias having difficulty in representing the high frequency components of a function, while relaxation methods can resolve high frequencies efficiently but stall at moderate to low frequencies. Relaxation methods generally refer to iterative techniques used to solve PDEs numerically. They are especially useful when dealing with boundary value problems, which arise in physics and engineering applications. These methods involve approximating the solution of PDEs by iteratively refining guesses until the solution converges to the desired accuracy. The disclosed computing system and method exploit the spectral properties of the two approaches by combining them synergistically to develop a fast numerical meta-solver of PDEs at scale.

A meta-solver for PDEs generally refers to a higher-level algorithm or framework designed to efficiently solve a wide variety of PDE problems by automatically selecting or configuring specialized solvers. PDEs are used to describe various phenomena in fields like physics, engineering, and finance, but solving them often requires specialized numerical techniques based on the type of equation and boundary conditions. The disclosed meta-solver of the present disclosure may streamline this process by adapting to different PDE forms, optimizing and tuning different parameters, and providing modularity. For example, the meta-solvers of the present disclosure may automatically analyze the PDE type (e.g., elliptic, parabolic, hyperbolic) and choose the most appropriate solution methods, like finite element, finite difference, or spectral methods. Further, the disclosed meta-solvers may optimize parameters such as mesh size, time step, or solver tolerances to improve accuracy or efficiency, using ML-based or heuristic approaches to adjust these dynamically. The meta-solvers of the present disclosure may also provide an interface for integrating different types of solvers (e.g., domain-specific, hardware-optimized) and combining them based on the needs of the problem, facilitating hybrid approaches. The present disclosure automates the decision-making and configuration process for PDE solving, reducing the manual intervention required to select methods and tune parameters, thereby saving time and ensuring better performance across a variety of problems or applications.

As will be described fully below, the disclosed computing system and method relate to two broad classes of meta-solvers from which the optimal meta-solver will be discovered using multi-objective optimization with respect to user pre-defined requirements, e.g., accuracy, speed, generalization, stability, deployment/energy consumption, algorithmic scalability, parallelization capability, or memory cost. In the first class, the disclosed computing system and method may combine different neural operators with standard relaxation methods, leading to extreme parallel efficiency for a wide class of PDEs, not tractable with existing monolithic solvers. In the second class, the computing system and method of the present disclosure generate new hybrid solvers, which extract the (near) null-space vectors from the trained neural operators to construct a mapping to a subspace, in which the low-frequency component of the error can be effectively eliminated.

In some aspects, to achieve optimality, the computing system and method of the present disclosure transform the complicated structure of the Pareto front of optimal meta-solvers into the solution of simple differential-games. The Pareto front may generally refer to the set of trade-off solutions where no single solution can be considered strictly better than another in all performance metrics. This concept originates from multi-objective optimization and is used to identify the “non-dominated” solutions, where improving one objective (e.g., speed) would lead to a reduction in another objective (e.g., accuracy). The disclosed computing system and method may be configured to leverage efficient numerical solvers for solving simple differential games, leading to numerically and efficiently explore e.g., the non-convex Pareto front of optimal meta-solvers where the trade-off solutions between the objectives do not form a convex shape in the objective space. In other words, improving one objective (e.g., speed) requires disproportionately large sacrifices in another objective (e.g., accuracy) at certain points, leading to regions where solutions are highly inefficient compared to others. Non-convexity matters in meta-solvers, especially when dealing with complex and varied PDEs. Non-convex Pareto fronts often indicate that specialization may be needed, there is a high optimization cost, and inefficient regions may exist. For example, some solvers may be very good for specific types of PDEs (e.g., hyperbolic equations) but perform poorly on others. The trade-offs between solving different problem types may be non-convex. Optimizing the meta-solver for multiple objectives may lead to diminishing returns where achieving a small improvement in one metric becomes very costly in terms of others, leading to “pockets” of optimal solutions (i.e., regions in a solution space where locally optimal solutions exist, but they may not necessarily be globally optimal) rather than a smooth spectrum. Further, in non-convex fronts, there may be large regions of inefficiency, meaning that small changes in parameters (e.g., mesh size, time steps) may lead to disproportionately large trade-offs in performance.

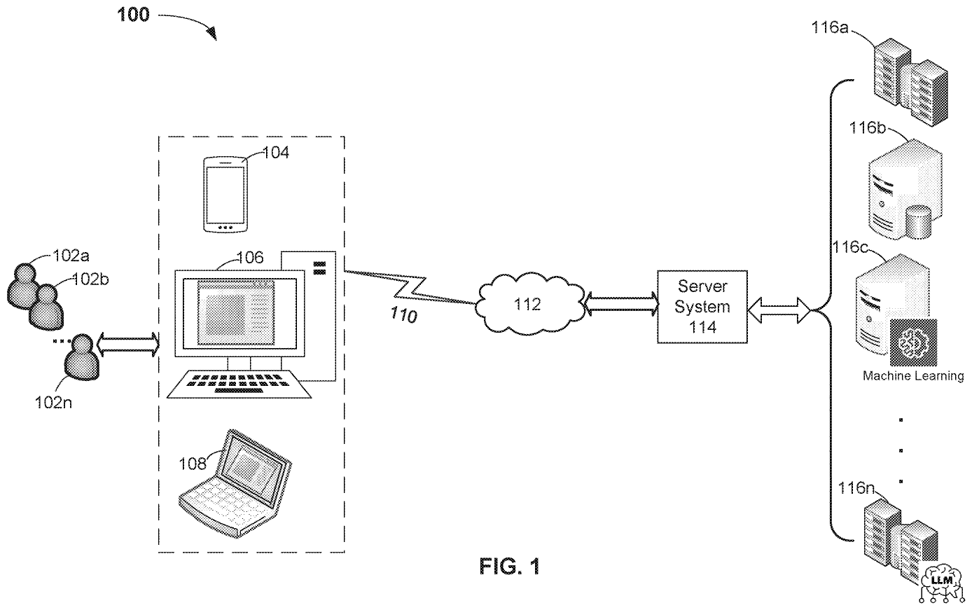

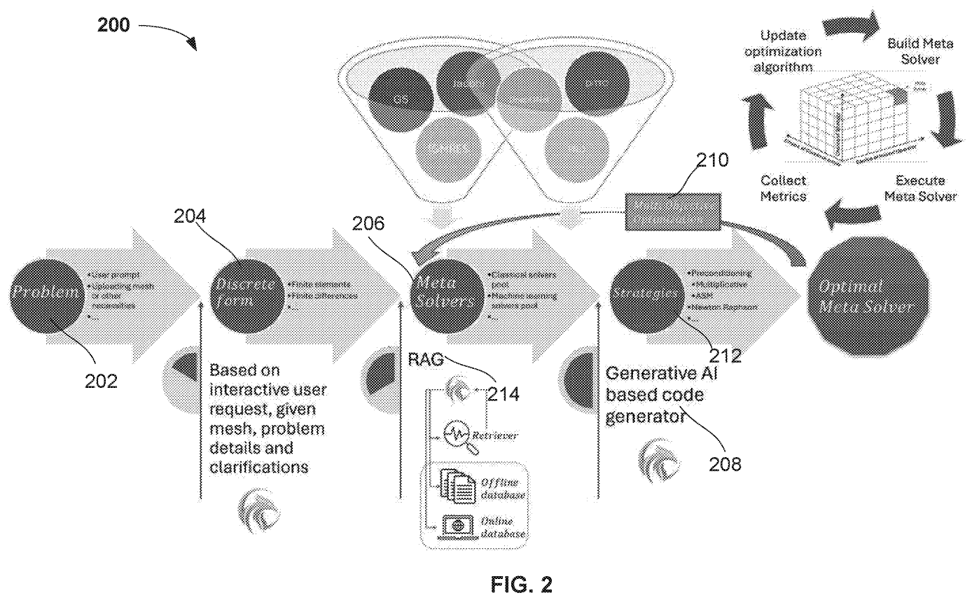

In accordance with various aspects of the present disclosure, FIG. 1 illustrates a diagram of an ML-based computing system deployed within a server-based computing environment and communication network and configured to receive a user input including e.g., a query to a large language model (LLM) to solve a specific problem (e.g., the collision dynamics of an automobile), automatically formulate a mathematical problem that is discretized with a pre-defined method, select various combinations of fundamental solvers and neural operators to form a Pareto front of viable solutions to the problem, dynamically construct an array of meta-solvers based on the selected combinations of fundamental solvers and neural operators, select the optimal meta-solver to solve the problem based on criteria such as accuracy, speed, generalizability, and stability, and generate and display problem solutions to the user based on outputs of the selected optimal meta-solver. The identification of the most effective meta-solver may be carried out by a multi-objective optimizer (MOO), which iteratively refines the choice. Being agnostic in terms of the differential equations, computational domains (shape and dimension), and discretization, the disclosed computing system and method not only enhance the efficiency of problem-solving but also leverage cutting-edge technologies to expand the frontiers of scientific inquiry for the best possible algorithm for a given problem. FIG. 2 illustrates a block diagram of an example workflow 200 of the ML-based computing system of FIG. 1.

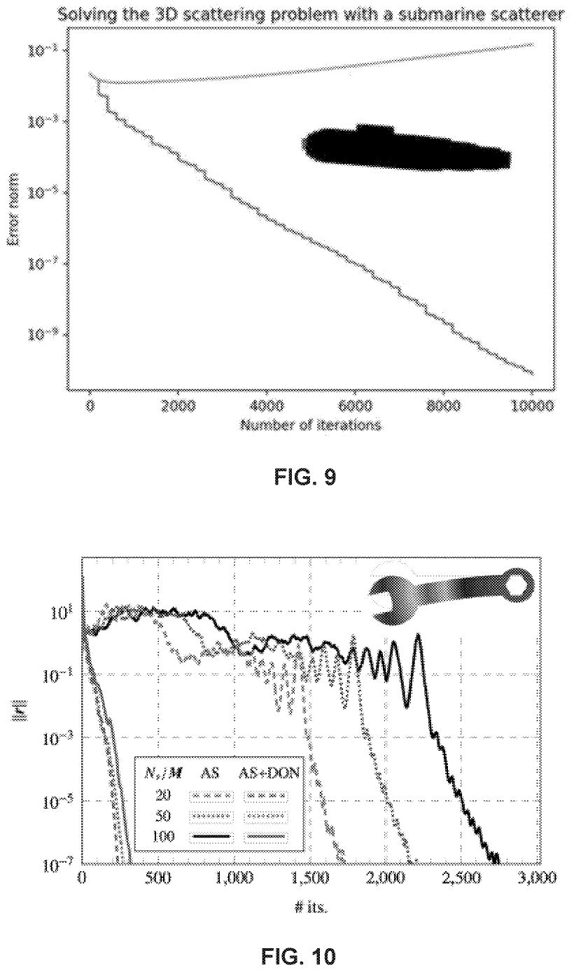

In one embodiment, as shown in FIGS. 1 and 2, the computing system 100 of the present disclosure may be configured to allow a user 102a, 102b, . . . 102n to use a selected computing device or system 104, 106, 108 to input a query to an LLM for solving a specific problem 202. Such a query may be in the form of a prompt like “Solve the Helmholtz question using Jacobi iterations.” The user 102a, 102b, . . . 102n may also control the creation of a solver from one or more prompts using the selected computing device or system 104, 106, 108 by uploading mesh or other necessities relating to the problem to be solved 202 by specifying the underlying parameters and the interface between the classical and ML components of the solver. In alternative embodiments, a mesh may not be necessary. The computing system 100 of the present disclosure may work in a continuum (no need to mesh at all) and a traditional solver may use grids as well, as shown below in FIG. 9. The computing system 100 may operate independently but can process information related to a mesh or grid if a user decides to upload one.

Each user input (query and/or data relating to a specific problem to be solved 202) may be transmitted to a server system 114, using suitable communication protocols 110 and at least one communication network 112. Here, the communication network 112 may generally include a geographically distributed collection of computing devices or data points interconnected by communication links and segments for transporting signals and data therebetween. The communication protocol(s) 110 may generally include a set of rules defining how computing devices and networks may interact with each other, such as frame relay, Internet protocol (IP), transmission control protocol (TCP), user datagram protocol (UDP), hypertext transfer protocol (HTTP). It should be appreciated that the computing system 100 of the present disclosure may use any suitable communication network, ranging from local area networks (LANs), wide area networks (WANs), cellular networks, to overlay networks and software-defined networks (SDNs), a packet data network (e.g., the Internet), mobile telephone networks (e.g., cellular networks, such as 4G or 5G), Plain Old Telephone (POTS) networks, and wireless data networks (e.g., Institute of Electrical and Electronics Engineers (IEEE) 802.11 family of standards known as Wi-Fi®, WiGig®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, virtual private networks (VPN), Bluetooth, Near Field Communication (NFC), or any other suitable network.

Thereafter, the server system 114 may be configured to train, host, incorporate or make an application programming interface (API) call to at least one of a plurality of computing systems 116a, 116b, 116c, . . . 116n to process the user input and generate responses. In a preferred embodiment, the plurality of computing systems 116a, 116b, 116c, . . . 116n may include one or more LLMs and machine learning models in order to process the received user prompt and data to identify an optimal meta-solver. An LLM is an AI model that may be capable of processing and generating human-like text based on the information it has learned from vast amounts of training data. The term “large” refers to the size of these models in terms of the number of parameters or weights, which are the values that the model learns during training to make predictions and generate text. LLMs may have millions, billions (or even more) parameters, which enable such models to capture complex patterns and nuances in language that, in turn, allow these models to understand and generate more natural-sounding text (relative to previous approaches). Examples of LLMs include the generative pre-trained transformer models (e.g., GPT-3, GPT-4, Codex), Pathways Language Model (PaLM), Gemini, Language Model for Dialogue Applications (LaMDA), Bard, Large Language Model Meta Artificial Intelligence (LLaMA), Claude, Orca, Turing-NLG, Command R, Mistral, Mixtral, Grok, BigScience Large Open-science Open-access Multilingual Language Model (BLOOM), Luminous, Titan, Tongyi Qianwen, Enhanced Representation through Knowledge Integration (ERNIE), PanGu, NeMo, XGen, StableLM, Character LLM, and even non-generative examples such as bidirectional encoder representations from Transformers (BERT), etc.

In some embodiments, the server system 114 may be a Cloud-based or an on-site server. The term “server” generally refers to a computing device or system, including processing hardware and process space(s), an associated storage medium such as a memory device or database, and, in some instances, at least one database application as is well known in the art. The server system 114 may provide functionalities for any connected devices such as sharing data or provisioning resources among multiple client devices or performing computations for each connected client device. According to one embodiment, within a Cloud-based computing architecture, the server system 114 may provide various Cloud computing services using shared resources. Cloud computing may generally include Internet-based computing in which computing resources are dynamically provisioned and allocated to each connected computing device or other devices on-demand, from a collection of resources available via the network or the Cloud. Cloud computing resources may include any type of resource, such as computing, storage, and networking. For instance, resources may include service devices (firewalls, deep packet inspectors, traffic monitors, load balancers, etc.), computing/processing devices (servers, central processing units (CPUs), graphics processing units (GPUs), random access memory, caches, etc.), and storage devices (e.g., network attached storages, storage area network devices, hard disk drives, solid-state devices, etc.). In addition, such resources may be used to support virtual networks, virtual machines, databases, applications, etc. The term “database,” as used herein, may refer to a database (e.g., relational database management system (RDBMS) or structured query language (SQL) database), or may refer to any other data structure, such as, for example a comma separated values (CSV), tab-separated values (TSV), JavaScript Object Notation (JSON), eXtendible markup language (XML), TeXT (TXT) file, flat file, spreadsheet file, and/or any other widely used or proprietary format. In some embodiments, one or more of the databases or data sources may be implemented using one of relational databases, flat file databases, entity-relationship databases, object-oriented databases, hierarchical databases, network databases, NoSQL databases, and/or record-based databases.

Cloud computing resources accessible using any suitable communication network (e.g., Internet) may include a private Cloud, a public Cloud, and/or a hybrid Cloud. Here, a private Cloud may be a Cloud infrastructure operated by an enterprise for use by the enterprise, while a public Cloud may refer to a Cloud infrastructure that provides services and resources over a network for public use. In a hybrid Cloud computing environment which uses a mix of on-premises, private Cloud and third-party, public Cloud services with orchestration between the two platforms, data and applications may move between private and public Clouds for greater flexibility and more deployment options. Some example public Cloud service providers may include Amazon (e.g., Amazon Web Services® (AWS)), IBM (e.g., IBM Cloud), Google (e.g., Google Cloud Platform), and Microsoft (e.g., Microsoft Azure®). These providers provide Cloud services using computing and storage infrastructures at their respective data centers and access thereto is generally available via the Internet. Some Cloud service providers (e.g., Amazon AWS Direct Connect, Microsoft Azure ExpressRoute) may offer direct connect services and such connections typically require users to purchase or lease a private connection to a peering point offered by these Cloud providers.

According to some implementations, an application, which may be a mobile or web-based application (e.g., native iOS or Android Apps), may be downloaded and installed on the selected computing device or system 104, 106, 108 for instantiating various modules for interacting with the user 102a, 102b, . . . 102n of the application, among other features. Such a user-facing application of the computing system 100 may include a plurality of modules and libraries executed and controlled by the microcontroller or processor of the hosting computing device or system 104, 106, 108 for performing functions locally on each computing device or making remote calls (e.g., API calls) to the server system 114 to access specific functionalities. The division of labor between local execution and server-side operations depends on how each library is designed and what its functions require.

In one embodiment, one or more libraries downloaded on the selected computing device or system 104, 106, 108 may be configured to perform all their operations locally without relying on the server system 114. That is, once a library is installed, it may access the resources and computing power available on each computing device 104, 106, 108 to execute tasks. For example, certain math libraries may be configured to perform computations locally using the device's CPU/GPU. Further, file handling libraries may be configured to process files stored on the local device. If pre-trained ML models are included in the library, they can run locally, depending on each device's capabilities. Local execution of these libraries may not require any Internet connection. Since there is no network latency, execution is faster for these local operations. Further, there is a greater control over data privacy, since no data needs to be sent to an external server. However, limited by each device's hardware (e.g., memory, processing power), local execution may involve downloading potentially large libraries, models, or datasets.

According to another embodiment, remote execution (server-side processing) may be implemented, and libraries downloaded on each computing device 104, 106, 108 may make remote calls (e.g., API calls) to the server system 114 to access certain functionalities, for example, when the functions a library provides are too resource-intensive for local execution or require access to constantly updated data (e.g., real-time services, large-scale models, or databases). In this case, the library acts as a client-side interface that makes API requests to the server system 114 to perform specific tasks.

For example, upon receiving the problem 202, a library downloaded on a selected computing device 104, 106, 108 may prepare and send a request to the server system 114 over the communication network 112 (e.g., Internet) for identifying an optimal meta-solver for the problem 202. This may be done via HTTP(S) in the form of REST, GraphQL, or other API protocols (e.g., my_library.get_data(query_params)). The server system 114 may perform the heavy computational tasks, access large databases, or run AI/ML models that the selected computing device 104, 106, 108 cannot handle locally. In an embodiment, the server system 114 may use an LLM (e.g., at least one of a plurality of computing systems 116a, 116b, 116c, . . . 116n) hosted on the Cloud to generate a response. The server system 114 may send the LLM response back to the selected computing device 104, 106, 108 in response to the API call, and the library processes and displays the result to the user, or generates and displays outputs based on the server's response.

In one example, a library may interface with services like OpenAI's GPT, Google Cloud AI, or Amazon S3, where the computation may be carried out on the server system 114, and the selected computing device 104, 106, 108 sends requests and receives results. In another example, libraries like AWS SDK, Google Cloud SDK may allow interaction with Cloud storage to upload, retrieve, and manipulate data on the Cloud.

Server-side processing may offload heavy computation to powerful servers (e.g., at least one of a plurality of computing systems 116a, 116b, 116c, . . . 116n), provide access to real-time data and updated services, and being device-agnostic by working even on devices with limited resources (smartphones, tablets, etc.).

According to additional embodiments, libraries implemented on each selected computing device 104, 106, 108 may adopt a hybrid model, where some operations or computations may be performed locally, while more complex or resource-intensive tasks are offloaded to the server system 114. For example, basic computations, preprocessing, or user interface elements may be handled locally, while complex processing, data retrieval, or heavy computations (e.g., running large AI models or interacting with databases) are carried out via the server system 114.

It should be appreciated that each computing device (e.g., the computing device 104, 106, 108, the server system 114, and the plurality of computing systems 116a, 116b, 116c, . . . 116n, and other devices and systems) deployed within the computing system 100 may include one or more data storage units that are coupled to the corresponding processor of each device and configured to store at least a portion of information obtained by each computing device and at least one set of data structures or instructions (e.g., software) embodying or utilized by at least one of the techniques or functions described herein. It should be appreciated that the term “non-transitory computer-readable” or “machine readable medium” may include a single medium or multiple media (e.g., one or more caches) configured to store at least one instruction. The term “computer-readable” or “machine readable medium” may include any medium that is capable of storing, encoding, or carrying instructions for execution by all modules of each computing device and that cause these modules to perform at least one of the techniques of the present disclosure, or that is capable of storing, encoding or carrying data structures used by or associated with such instructions. Non-limiting machine-readable medium examples may include solid-state memories, and optical and magnetic media. Specific examples of machine or computer-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks.

As noted above, neural networks may have difficulty in representing the high frequency components of a function, while relaxation methods can resolve high frequencies efficiently but stall at moderate to low frequencies. In some aspects, the server system 114 of the present disclosure may be configured to integrate neural networks and relaxation solvers to develop a fast numerical solver of PDEs at scale. According to one embodiment, the computing system 100 of the present disclosure may generate a HINTS by integrating a Deep Operator Network (DeepONet) with selected relaxation methods, leading to parallel efficiency and algorithmic scalability for a wide class of PDEs, not tractable with existing monolithic solvers. HINTS balances the convergence behavior across the spectrum of eigenmodes by utilizing the spectral bias of DeepONet, resulting in a uniform convergence rate and hence exceptional performance of the hybrid solver overall. Moreover, HINTS may be applied to large-scale, multi-dimensional systems, it is flexible with regards to discretizations, computational domain, and boundary conditions and it can be used to precondition as well.

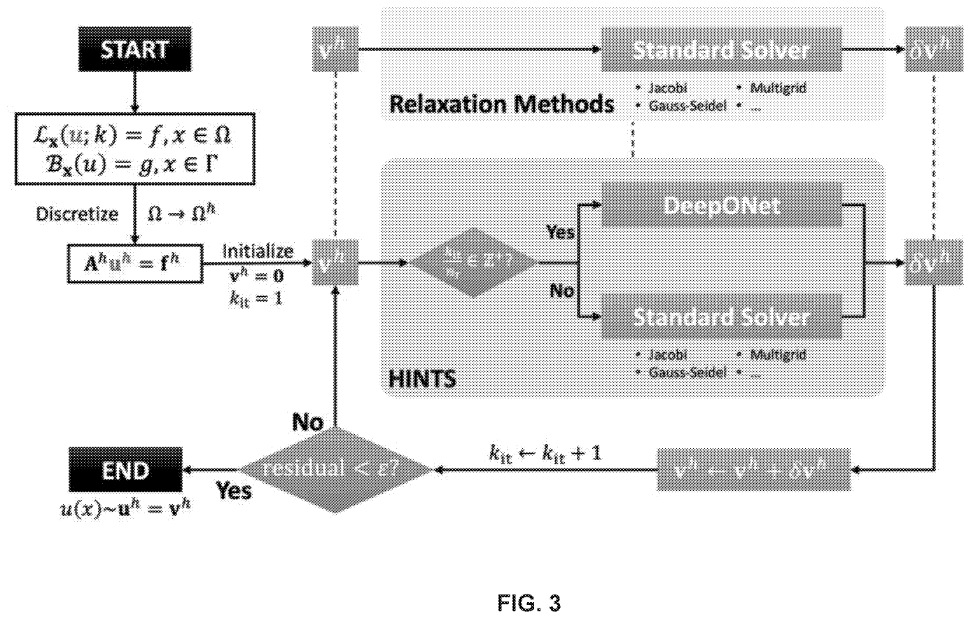

FIG. 3 illustrates an overview of the HINTS, according to aspects of the present disclosure. The goal is to solve u(x) in the differential equation. HINTS starts by discretizing the computational domain Ω into Ω^{h}, where h denotes the mesh size. The server system 114 may initialize a guess of the solution (v^{h}=0, for example). In the kᵢₜth iteration, the approximate solution v^{h} is corrected by δv^{h} through either the DeepONet solver or the standard numerical solver. The choice of the solver may be determined by whether nᵣ divides kᵢₜ, where nᵣ is a parameter selected to optimize the performance. There is a plurality of choices for the numerical solver, such as Jacobi, Gauss-Seidel, and multigrid methods. The algorithm proceeds until the residual of the underlying PDE is smaller than a threshold ε.

Specifically, considering the following linear differential equation Eq. 1:

$${ℒ}_{x} ( u ; k ) = f , x ∈ Ω \qquad ( 1 a )$$

$${ℬ}_{x} ( u ) = g , x ∈ \partial Ω \qquad ( 1 b )$$

where [symbol] is the differential operator, Bₓ is the boundary operator, k=k(x) parameterizes [symbol] , ƒ=ƒ(x) and g=g (x) are the right-hand-side and boundary terms, and u=u(x) is the solution. Assuming that g is a known fixed function, Eq. 1 defines a family of differential equations parameterized by ƒ and k.

Before employing HINTS, in one embodiment, the server system 114 may be configured to train a DeepONet offline.

This DeepONet approximates the solution operator G defined by

$$𝒢 : k , f ↦ u s . t . Eq . \text{?} holds , \qquad ( 2 )$$

where the uniqueness of the solution u has been assumed. DeepONet receives k(x) and ƒ(x) in the form of discrete evaluations on n_{D}+1 uniform points, respectively. This discretization is associated with DeepONet as Ω^{h}^{_{D}}.

Referring back to FIG. 2, based at least on interactive user request and the input problem 202, given mesh, problem details and clarifications, the differential equation corresponding to the problem 202 may be discretized into linear systems 204. Traditional solvers usually adopt a fixed relaxation method in each iteration. HINTS, on the other hand, creates a second branch of the iterator using a trained DeepONet. During the process of the iterative solution, the server system 114 may alternately adopt the numerical iterator and the DeepONet iterator with ratio 1:(nᵣ−1) (i.e., DeepONet with proportion 1/nᵣ), until the solution converges. The numerical iterator may be determined from established solvers, such as the Jacobi method, the Gauss-Seidel method, etc.

Among the numerical iterators, the server system 114 may use the (damped) Jacobi method, formulating the HINTS-Jacobi. For a class of problems defined by Eq. 1, the target is to compute the solution u(x) given k(x) and ƒ(x). The algorithm starts by discretizing the domain Ω into Ω^{h} and assembling the n-dimensional linear system A^{h}u^{h}=f^{h}. In each iteration, given the previous approximate solution v^{h} (≈u^{h}), the algorithm seeks to solve δv^{h} in A^{h}δv^{h}=r^{h} where the residual r^{h} is defined as the following:

$${r}^{h} := {f}^{h} - {A}^{h} {v}^{h} , \qquad ( 3 )$$

and then make a correction to the previous v^{h} by v^{h}←v^{h}+δv^{h}. To calculate the correction δv^{h}, either DeepONet or the Jacobi solver may be invoked by the server system 114. For the DeepONet solver, it takes k(x) and r(x) (function-form residual corresponding to the vector-form rh) as inputs, and yields v(x)=δv^{h} as the output. The algorithm proceeds until the residual is sufficiently small. The server system 114 may be configured to replace Jacobi with any other relaxation method, giving rise to different variants of the HINTS algorithm. For instance, using Gauss-Seidel relaxation leads to the HINTS-GS method.

In another embodiment, the server system 114 may combine DeepONet with multigrid methods, yielding the HINTS-MG. Within a multigrid algorithm, the server system 114 may replace a relaxation at each grid level by the HINTS-based relaxation. This is of particular interest for problems, for which the standard relaxation methods do not constitute effective and numerically robust smoothers, such as Helmholtz problems.

In some implementations, the DeepONet solver may be flexible with regards to the domain discretization of the numerical problem. A DeepONet trained on discretization Ω^{h}^{_{D}} may be transferred to a numerical problem with another discretization Ω^{h}, by simply including an interpolation step in the input side of DeepONet. This enables a HINTS to be used for solving equations equipped with different discretizations, involving different mesh densities, non-uniform meshes, and/or irregular meshes. It is also possible to extend DeepONet to a different domain using the technique for domain adaptation.

According to various embodiments, the HINTS of the present disclosure may be employed for the following two prototypical equations:

### Poisson Equation:

$$∇ \cdot ( k ( x ) ∇ u ( x ) ) + f ( x ) = 0 , x ∈ Ω ⊂ {ℝ}^{d} \qquad ( 4 a )$$

$$u ( x ) = 0 , x ∈ \partial Ω ; \qquad ( 4 b )$$

### Helmholtz Equation:

$${∇}^{2} u ( x ) + {k}^{2} ( x ) u ( x ) = f ( x ) , x ∈ Ω ⊂ {ℝ}^{d} \qquad ( 5 a )$$

$$u ( x ) = 0 , x ∈ \partial Ω . \qquad ( 5 b )$$

The Helmholtz equation is indefinite for sufficiently large k(x), making it hard to solve by many classical solvers. As will be described fully below, a series of numerical examples based on the HINTS of the present disclosure may be presented for the two equations, including different spatial dimensions, different discretization techniques, and different geometries.

### Poisson Equation in One Dimension

A prototypical Poisson equation in one dimension may be defined in Ω=(0, 1). The goal of HINTS-Jacobi is to solve this equation with arbitrary k(x) and ƒ(x). The server system 114 may first train a DeepONet with paired data [k(x), ƒ(x)] (generated by a Gaussian random field (GRF). After training, the HINTS-Jacobi may be employed to solve for new instances of k(x) and ƒ(x). Here, the same discretization may be used for the DeepONet and the numerical problem (n_{D}=n=30).

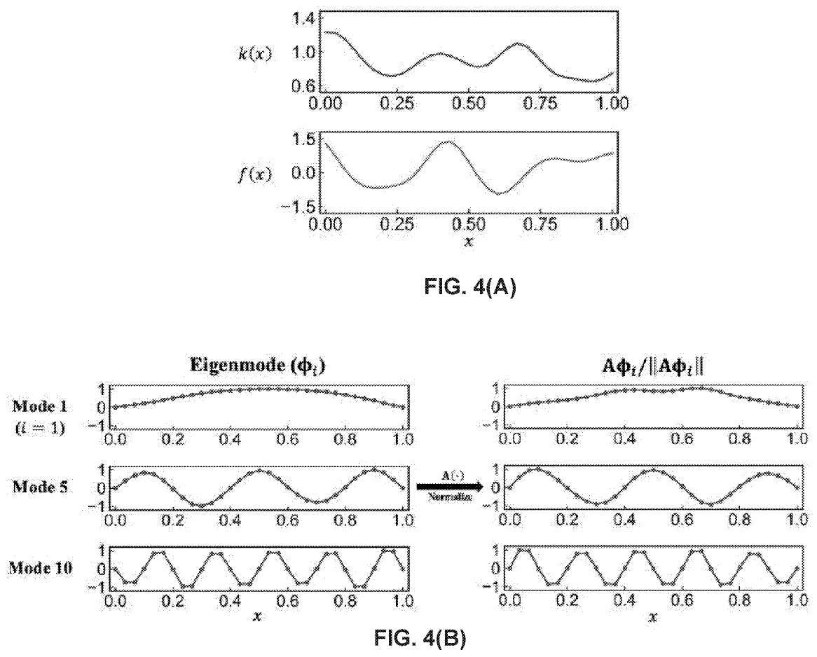

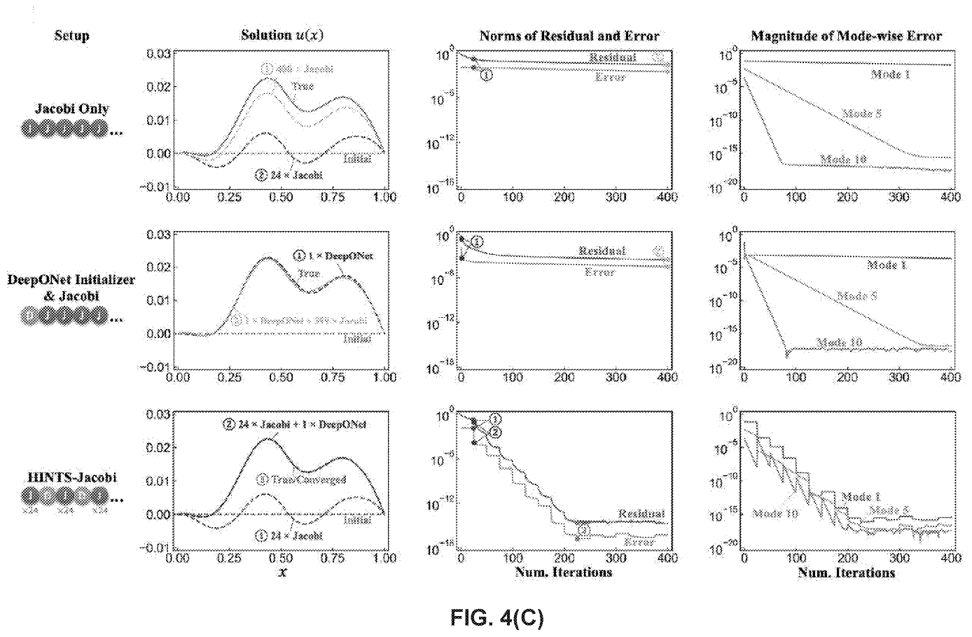

FIGS. 4(A), 4(B), and 4(C) show the performance of HINTS-Jacobi for a representative choice of (k(x), ƒ(x)). Results for other (k(x), ƒ(x)) and for HINTS-GS shows the profiles of k(x) and ƒ(x) considered. FIG. 4(B) shows the profiles of typical eigenmodes

$${∅}_{i}^{h}$$

(Øᵢ(x); i∈{1, 5, 10} of the solution u(x) and corresponding loading vectors

$$( \frac{{A}^{h} {∅}_{i}^{h}}{‖ {A}^{h} {∅}_{i}^{h} ‖} ) ,$$

where mode 1 refers to the lowest-frequency and mode 10 is a relatively high frequency. FIG. 4(C) presents the numerical results for three setups: (M1) Jacobi solver; (M2) Jacobi solver initialized with a single DeepONet inference; (M3) HINTS-Jacobi ( 1/25). Specifically, FIG. 4(C) shows key snapshots of the approximate solution and the norms of residual and error of the approximate solution, where the reference solution is obtained using a direct solver. After 400 iterations, the approximate solution of M1 is still visually different from the true solution u(x), with the absolute error being [symbol] (10⁻²). M2 provides a better estimate, with an absolute error [symbol] (10⁻⁴) that is substantially smaller than M1. However, the contribution of the one-time DeepONet initialization in M2 is marginal—it does not change the convergence rate, and the solution is still far from the convergence. On the contrary, M3, i.e., HINTS-Jacobi, provides a solution that rapidly converges to machine zero within roughly 200 iterations.

The last column of FIG. 4(C) displays the history of the eigenmode-wise error for modes 1, 5, and 10. For all the setups, the convergence rate of the embedded Jacobi iterations is uniform for each mode, matching the theoretical analysis. For Setups M1 and M2, the slow convergence of mode 1 in the Jacobi solver is the bottleneck of the overall convergence rate. The embedded DeepONet iterations, on the other hand, make a substantial difference in M3. DeepONet iterations significantly reduce mode−1 error, hence breaking the bottleneck effect in restricting the overall convergence rate. While DeepONet iterations have limited improvements for mode 5 and even negative effects on mode 10, these two modes are well resolved by the Jacobi solver. As such, the mixture of the two solvers functions in a synergetic way: the Jacobi solver is efficient for high-frequency modes but not for low-frequency modes; the DeepONet solver provides fast approximate solutions for low frequencies but may pollute the high frequencies. A proper combination of these two methods synchronizes the convergence paths and enables fast and uniform convergence across all eigenmodes.

### Solving Equations Involving Indefiniteness

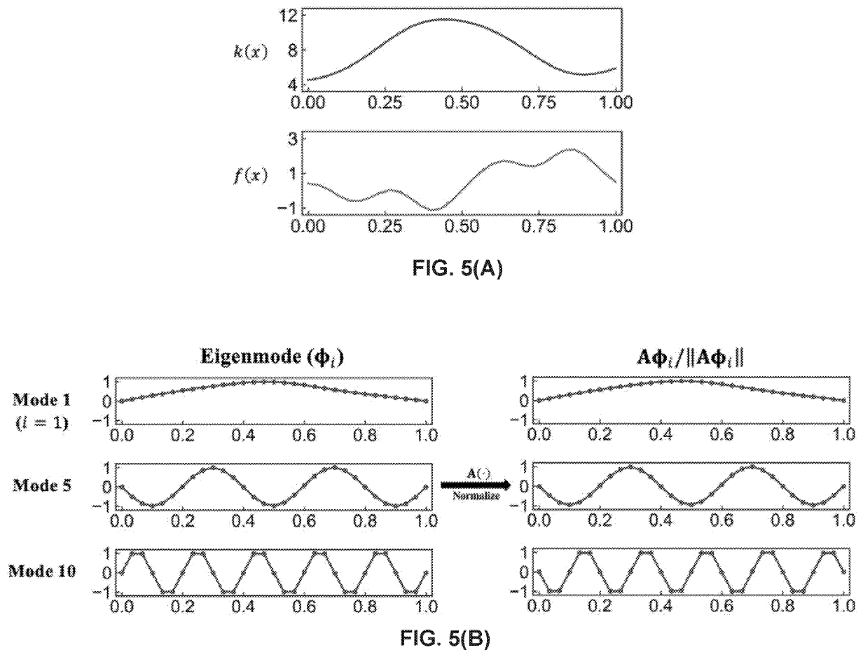

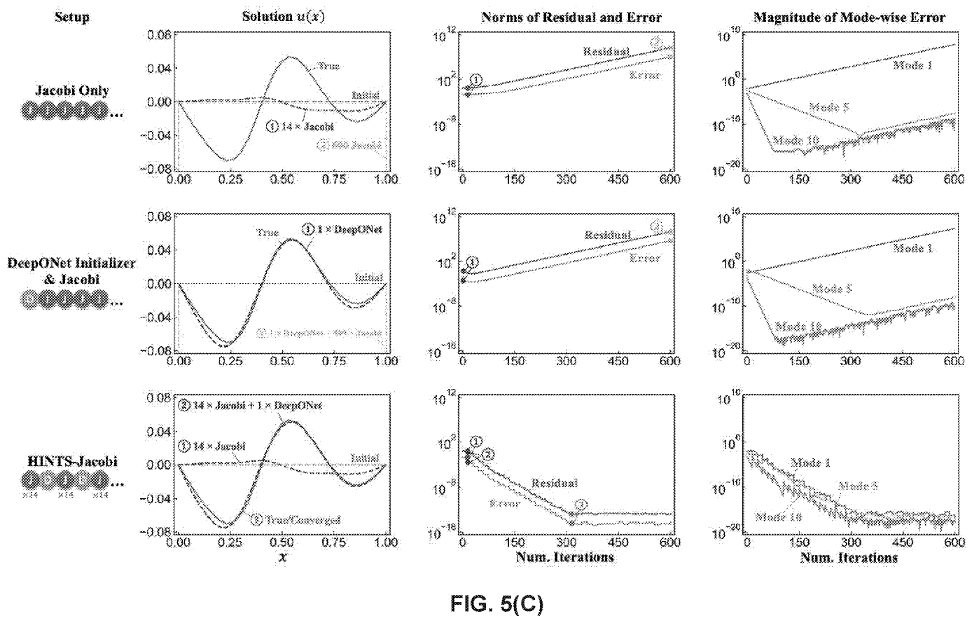

In the preceding example of the Poisson equation, the linear system is positive definite, which can be solved by majority of classical numerical solvers. Next, the server system 114 may use the 1D Helmholtz equation (Eq. 5) in Ω=(0, 1), where the indefiniteness causes a divergence of many classical solvers. After the offline training of a DeepONet, the server system 114 may use the HINTS-Jacobi to solve for new instances k(x) and ƒ(x) with the same discretization factor n=n_{D}=30. The results are displayed in FIGS. 5(A), 5(B), and 5(C). FIG. 5(A) shows the profiles of k(x) and ƒ(x) considered. FIG. 5(B) shows the profiles of typical eigenmodes

$${∅}_{i}^{h}$$

(Øᵢ(x); i∈{1, 5, 10} of the solution u(x) and corresponding loading vectors

$$( \frac{{A}^{h} {∅}_{i}^{h}}{‖ {A}^{h} {∅}_{i}^{h} ‖} ) ,$$

where mode 1 refers to the lowest-frequency and mode 10 is a relatively high frequency. FIG. 5(C) presents the numerical results for three setups: (M1) Jacobi solver; (M2) Jacobi solver initialized with a single DeepONet inference, i.e., one-time usage of DeepONet followed by Jacobi iterations; (M3) HINTS-Jacobi (with a DeepONet-to-Jacobi ratio 1:14). The first two setups diverge due to the divergence of low-frequency modes for indefinite systems. Setup M3, i.e., the HINTS-Jacobi ( 1/15), is capable of converging after roughly 300 iterations. Here, HINTS-Jacobi functions in a similar but not identical way as for Poisson equation—the DeepONet solver decreases the error of low-frequency modes, counteracting the Jacobi solver that slowly increases the error, while leaving high-frequency modes to be handled by the Jacobi solver. The HINTS-Jacobi resolves the issue of divergence for indefinite systems, caused by amplification of the low-frequency error components, which is prevalent for the classical stationary methods.

### Applicability to Higher Dimensions and Irregular Geometries

The effectiveness of HINTS of the present disclosure is not limited to one-dimensional problems equipped with uniform grids. Due to the discretization transferability, HINTS may adapt to an irregular computational domain (e.g., triangular Ω) and/or irregular discretizations (e.g., Ω^{h} with triangular elements). The following examples may be considered:
2D Poisson equation defined in an L-shaped domain: Ω:=(0, 1)²\[0.5, 1)²;
3D Helmholtz equation defined in a unit cube: Ω:=(0, 1)³.

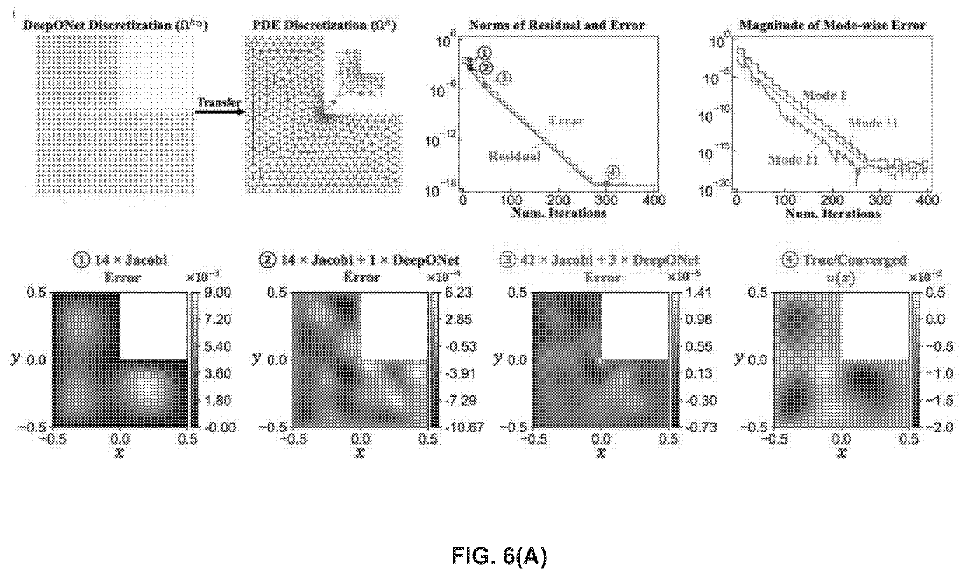

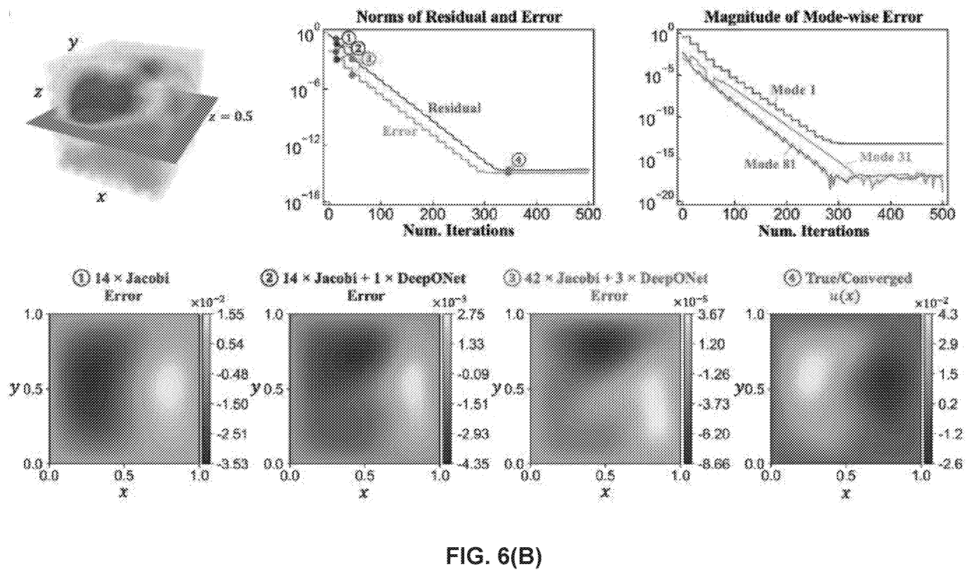

The geometries in the first column of the first rows are illustrated in FIG. 6(A) (2D Poisson) and FIG. 6(B) (3D Helmholtz). In particular, the case of 2D Poisson equation uses finite element discretization with linear triangular meshes (Ω^{h}), while a DeepONet is trained on a uniform mesh (Ω^{h}^{_{D}}). Both cases adopt the DeepONet proportion 1/15. The remaining results in the first rows of FIGS. 6(A) and 6(B), similar to 1D cases, show the histories of the norms of the residual, error, and the mode-wise error. The second rows of FIGS. 6(A) and 6(B) show the error of three key snapshots during the iterations together with the true/converged solution. For the case of 3D Helmholtz equation, the cross section is displayed at z=0.5. In both cases, DeepONet iterations significantly reduce the errors or low-frequency modes, hence accelerating the convergence of the solution.

Integrating HINTS with Multiscale Methods

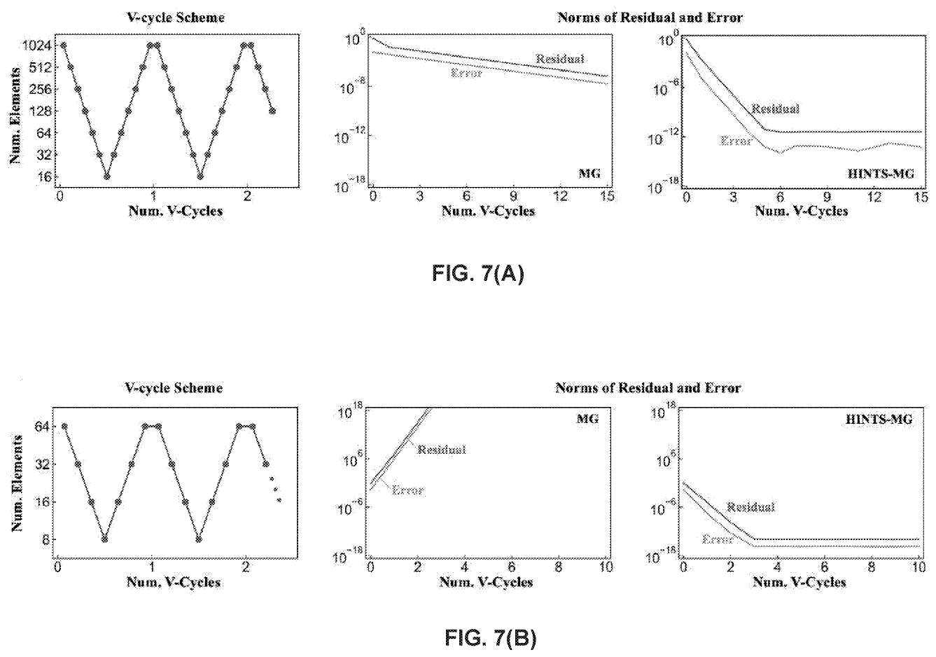

In some implementations, the DeepONet augmented iterative methods may be employed as subspace solvers for large-scale multiscale methods, e.g., multigrid or domain-decomposition methods. This is of particular interest for problems for which efficient, robust, and numerically stable subspace solvers are not straightforward to construct using standard numerical approaches. The HINTS of the present disclosure is a hybrid solver that integrates DeepONet with multigrid methods. Specifically, HINTS-MG may be used to solve the 1D Poisson equation and the 2D Helmholtz equation, with the results shown in FIG. 7(A) and FIG. 7(B), respectively. For the 1D Poisson equation, the server system 114 may use the same k(x) and ƒ(x) as shown in FIG. 4(A). The server system 114 may discretize the domain into n=1024 uniform intervals, and adopt the V-cycle scheme with 7 levels (see FIG. 7(A)). The server system 114 may have two setups for relaxation: (M1) Gauss-Seidel relaxation only; (M2) HINTS-MG with DeepONet-GS relaxation (DeepONet proportion 1/10). FIG. 7(A) presents the histories of the norms of residual and error (second column) and the mode-wise error (third column) against the number of V-cycles. By introducing DeepONet, the number of V-cycles needed for achieving convergence is significantly decreased to roughly 5. For the 2D Helmholtz equation, FIG. 7(B) shows the results for n=64² and four grid levels. While the multigrid solver with standard Jacobi relaxation diverges, due to amplification of low-frequency components of the error on all levels, HINTS-MG converges within approximately three V-cycles. Notably, due to the capability of HINTS in handling different discretizations at the training and testing stages (i.e., Ω^{h}^{_{D}}≠Ω^{h}), one single DeepONet may be used to handle all the grid levels.

### Generalization Capability of the HINTS

To investigate the applicability of HINTS for large-scale engineering problems with practical importance, its generalization capabilities need to be determined.

Generalization to different discretizations: The HINTS of the present disclosure can be transferred to solve equations where the domain discretization is different from that in the training stage, i.e., Ω^{h}^{_{D}}≠Ω^{h}. The generalization capability across different discretizations of HINTS is significant for the adaptability and practical utility of HINTS, extending beyond the results shown in FIG. 6(A).

Generalization to out-of-distribution input functions: the performance of HINTS using unseen function instances drawn from the same GRF distribution as the training data has been tested. The performance of HINTS with out-of-distribution functions has been shown, where the GRF has different correlation lengths. Results indicate that the HINTS can well generalize to higher correlation lengths; for smaller correlation lengths, the convergence is slightly slower than the former case, but still significantly faster than without employing DeepONet. This may be attributed to the accurate prediction of the DeepONet for low-frequency modes.

Generalization to different computational domains and boundary conditions: The HINTS applies to irregular computational domains and boundary conditions other than zero Dirichlet, as shown in FIGS. 6(A) and 6(B), respectively. Moreover, a HINTS trained with a fixed boundary condition and within one computational domain may be generalized to another similar but not identical domains, with an altered boundary condition, without re-training the DeepONet.

### Large Systems and Preconditioning

In yet another aspect, the HINTS of the present disclosure may solve large-scale problems (n> [symbol] (10⁶)). Notably, due to the generalization capability of discretizations, a lightweight HINTS may be employed, i.e., with a DeepONet trained using coarse meshes.

In one aspect, the HINTS of the present disclosure may enhance the convergence and the scalability through preconditioning. For example, the HINTS may be integrated into the software package PETSc. This integration demonstrates the ability of the HINTS to integrate into existent, well-established software packages. Moreover, HINTS may integrate with several readily available large-scale, state-of-the-art solution strategies, giving rise to a wide range of HINTS-based solvers or preconditioners, e.g., HINTS-Jacobi, HINTS-ILU, or HINTS-MG.

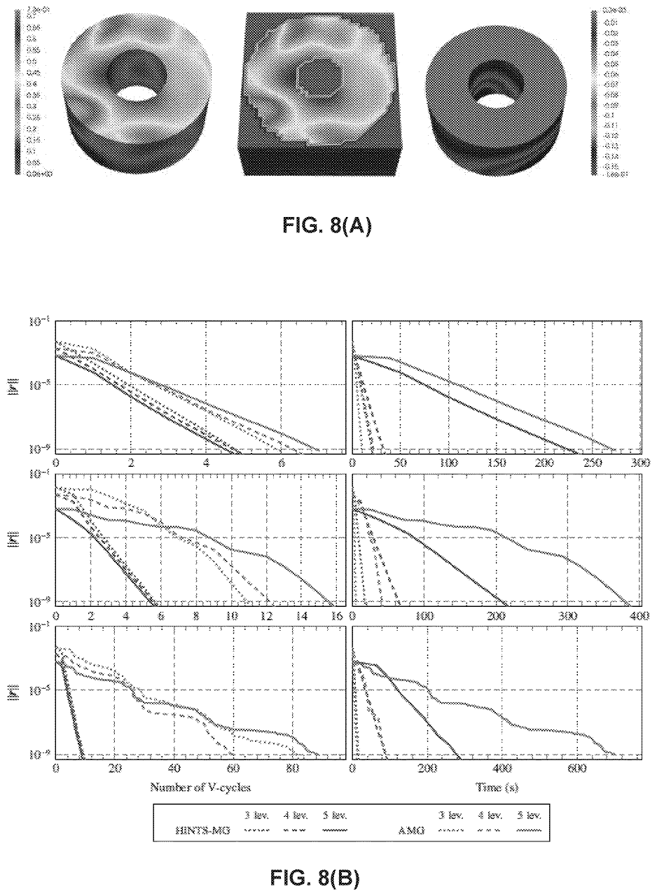

For example, the Helmholtz problem (Eq. (5a)) may be solved using the unstructured geometry of an annular cylinder, see FIG. 8(A) using F-GMRES. From left to right, FIG. 8(A) shows an example of generated right-hand side features, embedding of features into the uniform mesh considered by the DeepONet and the associated solution. FIG. 8(B) on left demonstrates the performance of HINTS-MG preconditioner, which is configured with a varying number of levels and HINTS-Jacobi relaxation. The MGs are configured with three/four/five levels (74, 712/570, 960/4, 462, 368 dofs). As shown, the F-GMRES with the HINTS-MG preconditioner converges with a fixed number of iterations, independently of the refinement level. In contrast, utilizing the algebraic multigrid (AMG) preconditioner, provided by the HYPRE and used in its default configuration, results in a slight increase in the number of F-GMRES iterations with increased refinement levels. Moreover, as the value of k increases, the convergence of the AMG deteriorates. The objective is not to employ the most optimized solution strategy for a given problem but rather to utilize a state-of-the-art black-box approach. This aligns with the main concept behind the proposed HINTS-based solvers/preconditioners, which use DeepONet to augment existent standard solution strategies with the aim of enhancing their convergence, robustness, and algorithmic scalability.

FIG. 8(B) on right compares the computational time required while using both preconditioners. The HINTS-MG is more costly for small-scale problems (n<0.5·10⁶). However, as soon as the problem size increases and the problem becomes more challenging (k increases), the benefits of the accelerated convergence are clearly reflected in the obtained timings, and the HINTS-MG preconditioner outperforms the HYPRE-MG by a significant margin.

As shown above, the HINTS of the present disclosure is fast, accurate, and widely applicable to diverse classes of differential equations. The present disclosure is agnostic in terms of the differential equations, computational domains (shape and dimension), and discretization.

As disclosed above in regard to the performance of HINTS-Jacobi, the embedded DeepONet solver provides fast, approximate solutions for low-frequency eigenmodes in the solution, while the embedded relaxation method handles the remaining higher-frequency eigenmodes, guaranteeing the convergence of the solver. Such a combination, instead of substitution, incorporates advantages from both ends, improving the performance beyond individual solvers. A hybrid methodology, instead of starting from scratch, retains the advantages from numerical solvers that have been studied for centuries as well as from DeepONet as a powerful operator approximator. While the DeepONet is trained with a finite dataset, the setup of HINTS enables the generalization into infinite test cases with the preservation of convergence to machine zero.

When training a deep neural network, one frequently observes a phenomenon called spectral bias. This refers to the fact that neural networks tend to learn the lower part of the spectrum first. The vast majority of applications of neural networks suffer from such a spectral bias, which inhibits the networks from learning complex mappings. On the contrary, the HINTS of the present disclosure exploits such a bias to tackle low-frequency modes that are otherwise difficult for classical solvers. Leveraging spectral bias may hold considerable potential for designing robust and scalable large-scale solvers. For example, in the context of AMG and domain-decomposition methods, constructing coarse space often requires knowledge of (near-)null-space vectors, a task that may not be well understood in practice for certain classes of problems, such as those with strong heterogeneities. Utilizing spectral bias, DeepONet can be used to construct the (near-)null-space vectors at low computational cost, in turn facilitating the construction of computationally efficient, scalable, and robust coarse spaces.

The HINTS of the present disclosure is promising in practical applications in many fields of real-world science and engineering. One may build HINTS based on existing numerical solvers, by adding a simple conditional statement to integrate DeepONet in a plug-and-play style. Upon the completion of a one-time, offline training procedure, the generalizability of HINTS enables its application for accelerating the solution process of a broad array of equations, with different parameters (e.g., source term, boundary conditions), discretizations, and even computational domains. Such a wide applicability effectively renders the training cost nearly insignificant. Furthermore, since DeepONet fits into the regular solver routine, the parallelization of HINTS depends solely on the parallelization capability of the employed iterative method. For instance, HINTS-Jacobi is inherently parallel, as the Jacobi method is parallel, and the DeepONet contribution can be evaluated at each computing device for the required nodal point. This makes HINTS especially well-suited for solving multidimensional, large-scale systems of practical interest.

The HINTS of the present disclosure represents a general class of frameworks, where one integrates operator regressors with standard numerical solvers. For example, other solvers may be integrated on both sides. Further, variability regarding geometric domain, boundary conditions, etc., may be determined for different problems of interest. In addition, a similar methodology may be extended to nonlinear problems, which are of more practical importance and are more difficult to solve. Finally, the offline cost of training DeepONet can be greatly reduced by transfer learning as different problems are solved on diverse geometric domains or set of parameters.

### Brief Review of the Employed Methods

### Numerical Solvers

In the study related to the Jacobi solver, the computing system 100 of the present disclosure may use a damped Jacobi method, with a damping parameter ω=⅔ for one-dimensional cases, ω=⅘ for two-dimensional cases, ω= 6/7 for three-dimensional cases. These choices are shown to be optimal for Poisson equation. In the study related to multigrid methods, the computing system 100 may use V-cycles with Gauss-Seidel relaxation for all tests, except for the Helmholtz-cylinder example, where Jacobi relaxation is employed. The computing system 100 may implement the full-weighting version of the restrictor and the prolongator.

### DeepONet

In one embodiment, DeepONet of the present disclosure may use an architecture where k(x) (similarly for ƒ(x)) is fed into the branch network in the discrete form

$${[ k ( {x}_{0} ) , k ( {x}_{1} ) , … , k ( {x}_{n} ) ]}^{T} , where {\{ {x}_{i} \}}_{i = 0}^{{n}_{D}}$$

are uniform grid points in Ω. Then, for an arbitrary x∈Ω, which is received at the trunk network, DeepONet predicts u(x) that approximately satisfies Eq. (1). The branch network is a dense neural network for problems in 1D and a convolutional neural network for problems in multidimensions. In one embodiment, the server system 114 may be configured to enforce the Dirichlet boundary conditions by postprocessing DeepONet outputs for all cases except the 2D Poisson equation in an L-shaped domain. Specifically, for problems defined in Ω=(0, 1)^{d} (d∈{1, 2, 3}), the original output of the DeepONet is multiplied by x(x−1), xy(x−1)(y−1), xyz(x−1)(y−1)(z−1) for d=1, 2, 3, respectively. To ensure convergence to machine zero, the server system 114 may utilize the scaling of ƒ(x) in the DeepONet. Before feeding into the DeepONet, ƒ(x) is normalized. Then, the norm is multiplied by the output of the DeepONet.

### Hints

Note that DeepONet predicts the correction of the solution corresponding to the current residual (see Eq. 3). To solve a single differential equation with a specified k(x) and ƒ(x), DeepONet iterations take the same k(x) as the first input in Eq. 2 but different right-hand-sides terms r(x) corresponding to the current residual in the iterative process as the second input. Before invoking the DeepONet solver, the server system 114 may convert the matrix-(vector-) form residual r^{h} into the function-form residual r(x). In addition, for numerical examples involving different discretizations of DeepONet and the numerical problem (i.e., Ω^{h}≠Ω^{h}^{_{D}}), the server system 114 may interpolate Ω^{h} into Ω^{h}^{_{D}} before feeding the data into DeepONet. No additional steps may be needed on the output side, since DeepONet is capable of evaluating the output function for Ω^{h}.

In some aspects, the present disclosure may identify optimal meta-solvers using GenAI for linear systems by combining the efficiency of Neural Operators (NOs) with the accuracy and reliability of standard numerical approaches to design efficient, accurate, and highly scalable iterative methods. In some implementations, the construction of the meta-solver may use subspace correction methods, such as multilevel and domain-decomposition (DD) methods due to their scalability and optimal complexity for specific classes of problems, such as elliptic PDEs. They rely on two essential algorithmic components: the choice of appropriate subspaces and the corresponding subspace solvers. However, the construction of these components is challenging and not yet well understood for many practical applications, such as non-elliptic PDEs or coupled problems. The computing system 100 of the present disclosure may explore the potential of NOs to extend the applicability and efficiency of these methods to a broader range of linear problems. To fully automate the construction of subspaces and subspace solvers, the computing system 100 may employ GenAI for the implementation and MOO for determining the optimal configuration of the discovered meta-solver, given the linear problem specification and the user's computational requirements.

### Hybrid Solvers—NO-Induced Subspaces

The efficacy and scalability of subspace correction methods are tightly connected to the choice of subspaces. For example, in the context of multilevel methods, constructing coarse spaces that can adequately capture low-frequency components of the error and smoothly varying features is crucial. Similarly, for designing algorithmically-scalable DD methods, such as the additive Schwarz (AS) preconditioners, the server system 114 may not only construct subdomains by ensuring the locality and load balancing but also devise a coarse space that facilitates effective global information transfer. To simplify and automate the coarse-space construction process in multilevel and DD methods, the server system 114 may use the spectral bias of DNNs, which allows them to efficiently capture global trends and low-frequency functions. In one embodiment, the server system 114 may build upon any coarse basis approximation for linear problems, where the coarse space may be constructed straight from using the DeepONet of in a more elaborate fashion. Coarse spaces induced by the DeepONet may give rise to scalable methods, even for problems with complicated variations and high contrasts in the coefficients. In one particular case, the traditional Nicolaides approach tends to be insufficient, and more advanced coarse-space construction techniques such as GENEO and subdomain DtN maps are computationally demanding. On the other hand, the TB approach may require the manual selection of suitable null-space vectors from the set of all vectors generated by the DeepONet and the choice of neural operator architecture. Therefore, referring to FIG. 2, to fully automate the discovery of subspaces process, the computing system 100 may utilize generative AI 208 and MOO 210 to determine the suitable neural operator architecture, such that it induces the most representative near null-spaces. Moreover, understanding how many and which near null-space vectors are necessary for constructing the subspace with sufficient approximation power will be crucial.

### Hybrid Solvers—NO-Enhanced Subspace Solvers

The efficacy of subspace correction methods is significantly influenced by the quality of the solvers associated with each subspace. However, designing a robust and efficient nonlinear subspace solver is often challenging and requires in-depth knowledge of the underlying problem. For instance, devising a smoother for multilevel methods in Helmholtz problems with high wave numbers is a tedious task, as standard approaches like Jacobi or Gauss-Seidel often fail due to the amplification of low-frequency error components. In one aspect, the computing system 100 of the present disclosure may be configured to determine how to hybridize standard stationary methods with NOs to enhance their convergence. For example, HINTS may be extended to a broader class of additively and multiplicatively composed subspace solvers for linear systems. The idea behind these methods is to alternate between a few iterations of a standard iterative method, effective in removing high-frequency components of the error, and a neural operator inference, effective in eliminating low-frequency components of the error, to effectively eliminate the error across the entire spectrum of frequencies. This, in turn, enhances the applicability, convergence, and robustness of the subspace solver. FIG. 9 illustrates results for a 3D Helmholtz problem, scattering around a submarine, where the top line represents the results using Jacobi, and the bottom line represents results using Jacobi and DeepONet. That is, hybridizing Jacobi with DeepONet enables convergence of an otherwise divergent iterative method for the scattering problem around a submarine. FIG. 10 illustrates the convergence of the conjugate gradient algorithm, preconditioned with the AS method with and without hybridization with the DeepONet (DON) for solving linear elasticity in the 3D domain.

Similar to the construction of subspaces, fully automating the construction of subspace solvers may require determining which stationary method will be hybridized with which NO. Moreover, it is crucial to establish the rate at which the NO will be intertwined with the stationary method during the solution process. Furthermore, to train the NO, the dataset may be constructed to capture the frequencies that are not well resolved by the stationary method. To achieve this, the computing system 100 of the present disclosure may be configured to sample, for example, from a Gaussian random field with a carefully selected correlation length. As shown in FIG. 2, the MOO 210 and generative AI 208 may be used to guide the selection of these components.

### Meta-Solver Discovery

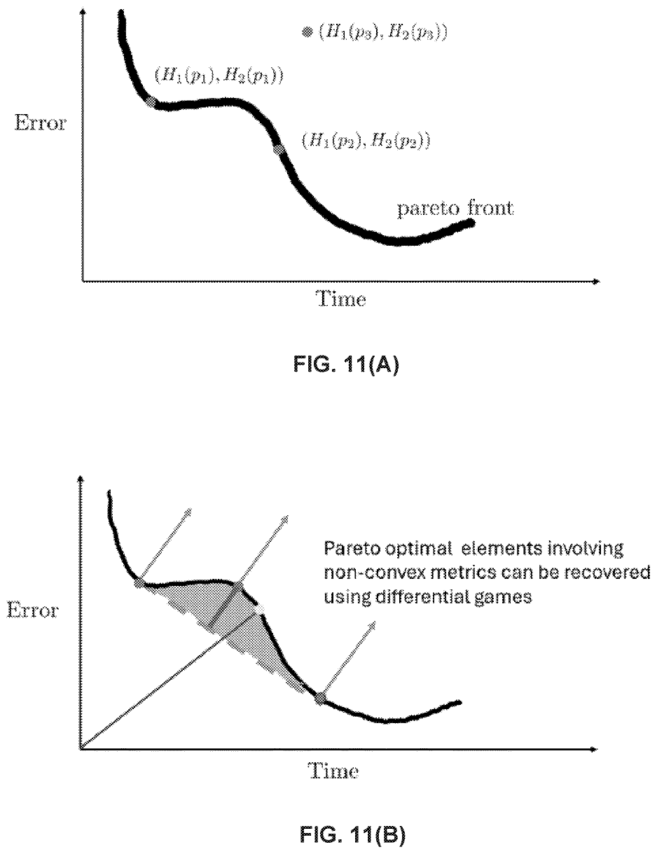

For a given linear PDE, such as a Poisson equation, elasticity, Helmholtz with varying coefficients or right-hand sides, etc., the server system 114 may first obtain the discrete system using a specified numerical discretization method. Then, to create a hybrid solver, the server system 114 may select an appropriate numerical solver from a silo, e.g., Jacobi, Gauss-Seidel, Chebyshev smoother, and so on. A similar choice is made for the ML solver from a list of neural operators, e.g., DeepONet, FNO, Laplace Neural Operator, Vision Transformer Operator, etc. Afterwards, an optimization strategy 212 may be determined by the server system 114 of the computing system 100 to discover the most suitable hybrid subspace correction meta-solver, given a user's specified requirements and constraints, for example in terms of computational resources. Since the space of available solvers is infinite, especially taking into account all the hyper-parameters associated with the network architectures and the structure of subspace correction method, the server system 114 may create a rich plurality of meta-solvers for a specific class of PDE. For each particular solver configuration, the server system 114 may compute the performance metrics and decide on the one that performs the best. However, to select the most efficient variant, one needs to test many different solver configurations to collect performance metrics. The server system 114 may use advanced optimization techniques to, instead of brute-force solving with many solvers, reach a decision on an optimal solver by using innovative MOO techniques, as shown in FIGS. 11(A) and 11(B). FIG. 11(A) shows the Pareto front in black and three meta-solvers with parameters p1, p2 and p3. (H₁(p₁), H₂(p₁)) and (H₁(p₂), H₂(p₂)) are Pareto optimal while (H₁(p3), H₂(p3)) is not. FIG. 11(B) shows the convexification of the Pareto front when the scalarization technique is considered for non-convex metrics. The green-dashed line represents the convexification of the Pareto front. The green arrows are orthogonal to the green dashed line, and the only three Pareto optimal elements with highlight in red circles that can be recovered using the scalarization technique. The purple line is generated by the vector (1,1) and the corresponding “preference” map is max (H₁(p), H₂(p)): the red line intersects the Pareto front at MS, which is exactly where H₁(p)=H₂(p). The blue area depicts the discrepancy between the Pareto front and its convexification. The red line measures the duality gap in the saddle-point formulation. The Pareto front can be explored by solving differential games. The outcome of this optimization process is the optimal subspace correction meta-solver, configured specifically for the given problem at hand according to the set of metrics employed in MOO, as specified below.

### Pareto Optimality, MOO Solvers and Surrogate Models

Discovering of optimal meta-solvers may include optimizing multiple metrics associated to a meta-solver. Therefore, it corresponds to a MOO problem where optimality is defined via Pareto optimality. According to one example, the server system 114 may denote by p∈ [symbol] the configuration set of meta-solvers and denote by Hᵢ: [symbol] → [symbol] , i=1, . . . , m the objective functions/performance metrics to minimize. To alleviate notations, the server system 114 may also consider H: [symbol] → [symbol] defined by H(p)=(H₁(p), . . . , Hₘ(p)). Hᵢ may be interpreted as Hamiltonians and therefore p as a momentum, which is consistent with notations in Physics. Pareto optimality is a standard concept of solutions for MOO problems and is defined so that none of the objective functions can be improved without degrading some of the other objective values. The precise definitions are as follows. An element p∈ [symbol] is called Pareto optimal if there does not exist q∈ [symbol] such that Hᵢ(q)≤Hᵢ(p) for all i=1, . . . , m and Hⱼ(q)<Hⱼ(p) for one j∈{1, . . . , m}. The set of all Pareto optimal elements is called the Pareto front. An element p ∈ [symbol] is called weak Pareto optimal if there does not exist q∈ [symbol] such that Hᵢ(q)≤Hᵢ(p) for all i=1, . . . , m. The set of all weak Pareto optimal elements is called the weak Pareto front. It follows that the Pareto front is a subset of the weak Pareto. A graphical illustration of the weak Pareto from is depicted in FIGS. 11(A) and 11(B). In one embodiment, derivative-free MOO solvers may be implemented. Each evaluation of the metrics Hᵢ(p) may be recorded when running the MOO solver. This data harvesting of metrics may be used to train a surrogate model for the multi-objective map p [symbol] (H₁(p), . . . , H₂(p)). In particular, a surrogate model may be studied using a DeepONet in order to obtain surrogate models for the metrics H which enjoy efficient numerical differentiation using automatic differentiation. This feature will be leveraged in the MOO solver 210 of FIG. 2.

### GenAI to Build Meta-Solvers

Building a solver involves a lot of coding as well as debugging. To explore the plurality of candidate solvers, many codes must be written and debugged, which is the most time-consuming part. The computing system 100 of the present disclosure may use a unique platform that allows for creating codes on-demand quickly and reliably, including automatic debugging. The platform uses a unique generative AI method (e.g., 208 of FIG. 2) to enable writing the codes of the meta-solvers. It unlocks the possibility to create a solver from a set of instructions, in this case—the choice of the classical solver, the choice of the NO, the MOO strategy, etc. From a simple description of a problem, a set of solvers may be coded on-demand to capture the meta-solvers space. The unique platform may be configured to enable creating large volumes of sophisticated codes from a user's request, and hence is a main pillar in this workflow. It will generate all the codes for the meta-solvers, fueling the optimization loop for the discovery of the optimal meta-solvers.

### Retrieval Augmented Generation (RAG)-Based Solver Selection

An optimal meta-solver for an elliptic problem may not be the optimal one for a hyperbolic one. In addition, a Helmholtz problem with a wave-number of 1 (elliptic), may be different from one with a wave-number of 6, and is also different from one with a wave-number of 60. The more problems to explore, the more meta-solvers to encounter. According to one implementation, the computing system 100 may create a meta-solver “bank” for storing the optimal meta-solvers per problem. When a new problem is at hand, and assuming a similar problem has already been investigated, the server system 114 may fetch the optimal meta-solver instead of executing the whole framework to discover the optimal meta-solver again. To achieve that, a RAG algorithm 214 may be used. The idea behind this approach is, given a corpus (in this case the bank of meta solvers), the server system 114 may first chunk the entire database, where each chunk represents a small code snippet, such as an individual meta solver code snippet or subroutines from meta solvers. The size of the chunks (to be investigated) brings a trade-off between the context window and the fetching efficiency. Thereafter, an LLM may be used to assign a vector embedding to each chunk. Last, when a new problem is at hand, the server system 114 may use the LLM to assign it a vector embedding and fetch the chunks that have similar embeddings. The generative capabilities of the LLM may be used to, using the chunks, either extract pieces of code or generate the required codes for writing the optimal meta solver.

NO-hybridized iterative solvers and preconditioners may solve a high wave-number indefinite Helmholtz problems, a Poisson problem with and without jumping coefficients, and elasticity problems. In one implementation, as the chosen NO solver, the server system 114 may employ DeepONet, and the hyperparameters of the numerical solver may be tuned empirically. As such, the server system 114 may not only solve the problems with predefined NO-hybridized numerical solvers but rather use a prompt to indicate the choice of meta-solver and strategy. The server system 114 creates solvers from scratch, demonstrating the ability to generate solvers-on-demand. A set of at least 10 different solvers per problem class may be determined with predefined parameters. Each of these solvers may be tested, and the server system 114 may gather metrics to construct a Pareto front. In addition, for a set of selected benchmark problems, the server system 114 may compare the convergence properties and performances of established solvers implementations with the generated implementations to ensure that the generated code produces the expected convergence of the iterative schemes at consideration.

In another embodiment, the server system 114 may systematically target elliptic and hyperbolic PDEs with the objective of discovering one new optimal meta-solver for each class of problems. For example, the server system 114 may include scalar equations but also systems of equations, such as the elasticity equations and the Maxwell's equations. The server system 114 may compare with the fastest methods available in PETSc for that specific problem.

### Identification of Optimal Meta-Solvers Using GenAI for Nonlinear Systems

In accordance with various aspects, the computing system 100 of the present disclosure may identify meta-solvers beyond linear settings, with a particular focus on nonlinear and time-dependent problems, such as advection-diffusion-reaction (ADR), Navier-Stokes, or nonlinear elastodynamics. For example, the server system 114 may utilize GenAI, Hamilton-Jacobi (HJ), and differential games to discover novel variants of nonlinear subspace correction methods, such as FAS or MG/OPT algorithms. Similarly to linear subspace correction methods, nonlinear subspace correction methods are well known for their scalability and optimal complexity for specific classes of problems. Moreover, there is currently no literature available on construction of hybrid multilevel meta-solvers for nonlinear problems.

### Hybrid Nonlinear Solvers: NO-enhanced Newton-Raphson Method

When solving nonlinear problems, such as the Euler equations widely used in high-speed flows, the computing system 100 of the present disclosure may employ the (globalized) Newton-Raphson method to tackle the nonlinearity. In this case, at each iteration, the nonlinear system may be first linearized, and then a linear system of equations is solved to obtain a search direction. As a consequence, the hybrid meta-solvers disclosed above may be directly applied to solve the arising linear systems. Notably, the speedup obtained by solving the sequence of emerging linear systems accumulates over all nonlinear iterations, intensifying the obtained computational savings. As in the linear case, the MOO 210 and HJ may be used to identify optimal hybrid linear meta-solvers, including subspace correction methods with NO-induced subspaces and NO-enhanced smoothers.

In some implementations, NO approaches may be used not only to reduce the cost associated with solving arising linear systems but also to directly enhance the convergence speed of the Newton-Raphson method. For example, performing a right-preconditioning iteration in a subspace of slowly varying functions may enhance the convergence speed of Newton's method. This approach resulted in an enlarged basin of attraction for Newton-Raphson's method and improved overall convergence speed, especially when the initial guess is located far from the solution. However, the resulting nonlinear preconditioner suffers from the relatively high computational cost associated with performing principal component analysis (PCA) on each nonlinear iteration. To overcome this difficulty, the computing system 100 of the present disclosure may leverage NOs to construct the nonlinear preconditioner. The server system 114 may construct a subspace preconditioner by extracting near-null space vectors from pre-trained NOs, such as DeepONet. Different sampling and dataset construction strategies may be used to ensure that the trained NOs capture the frequencies of error that are difficult to tackle by the Newton-Raphson method. Moreover, prior knowledge may be integrated into the trunk network's architectural design to further enhance the quality of the NO-induced near-null space vectors. The HJ and differential approaches will play a crucial role in identifying the optimal NO architecture and in determining the appropriate near-null space vectors from the pre-trained NOs.

### Hybrid Nonlinear Solvers: NO-Enhanced Nonlinear Multilevel Methods

Instead of utilizing subspace correction methods for the linearized systems, nonlinear multilevel methods may be employed to address nonlinearity directly in each subspace. This approach is particularly interesting for problems where standard, even globalized, single-level methods struggle to converge, whereas nonlinear multilevel methods are capable of obtaining a solution. The most frequently employed nonlinear multilevel subspace correction methods are the Full Approximation Scheme (FAS) or its globalized variants such as MG/OPT, or line-search-based FAS-like algorithms. These globalized methods rely on three key components. Firstly, first-order consistency between the fine and coarse-level optimization problems has to be imposed in the neighborhood of the current fine-level iterate. This ensures that the first coarse-level correction is a direction of descent with respect to the fine level. Secondly, the globally convergent smoother has to be employed at each level to guarantee convergence to stationary points on each level. In the end, a line-search strategy is employed in-between levels for prolonged coarse-level corrections to guarantee global convergence of the resulting multilevel scheme.

In the context of discovering optimal nonlinear multilevel meta-solvers, the server system 114 may be configured first to explore the design of hybrid coarse-level models such that the first-order consistency argument holds in a larger neighborhood of the restricted fine-level iterate. To this end, an NO may be trained to approximate the difference between the fine and coarse-level residuals/gradients for a given coarse level iterate. The successful realization of this step may enable the construction of more accurate coarse-level models, which would, in turn, allow for taking larger steps on coarse levels, thereby decreasing the computational cost of the overall solution process.

Afterward, the server system may identify the optimal nonlinear smoothers, as their performance has a major impact on the convergence of nonlinear multilevel schemes. In the context of FAS, several extensions of linear smoothers, such as nonlinear Jacobi and nonlinear Gauss-Seidel, may be used. Notably, the implementation of nonlinear Gauss-Seidel employs a Newton's method to resolve a local nonlinearity for each (block) coordinate and must therefore be implemented on an ad-hoc basis for each nonlinear problem under consideration. In certain aspects, the server system 114 may use GenAI and a library to generate suitable nonlinear smoothers, for a user specified nonlinear problem at hand. The generated stationary nonlinear smoothers may then be hybridized with NOs to enhance their convergence and ensure that no amplification of low-frequency components of the error occurs. In the context of globalized multilevel algorithms, the server system 114 may be configured to use the NO-enhanced nonlinear smoothers, such as nonlinear conjugate gradient, nonlinear GMRES, or nonlinear Anderson acceleration. Based on the preconditioning methods, the server system 114 may use NO-based preconditioning techniques to enhance the robustness, convergence, and applicability of nonlinear methods. The discovery of optimal NO-enhanced coarse-level models, as well as NO-enhanced smoothers, may be guided by differential games and HJ approaches, while efficient and scalable implementation will be carried out by GenAI accessible within the library associated with the server system 114.

Saddle-Point Formulation and Training methodology in SciML to Discover Pareto Optimal Elements

In one embodiment, a scalarization approach to solve MOO problems may include minimizing a non-negative combination of all objective functions. However, this scalarization technique may only expose the Pareto front when all Hi are convex. When objective maps are not convex, the scalarization approach can only expose specific Pareto front elements on the non-convex part of the Pareto front. This behavior is illustrated on FIGS. 11(A) and 11(B). Traditional MOO solvers try to mitigate this deficiency by incorporating line-search techniques.

In one aspect, the computing system 100 of the present disclosure may reformulate the search of Pareto optimal elements as a saddle-point problem which overcome the above issue. The main idea is to introduce a specific class of convex maps that describe a “preference” on the metrics that are desired to optimize (for instance, the map could emphasize the preference on minimizing the error rather than the computational time). Then, considering Fenchel-Legendre transform of the “preference” map may yield a saddle point problem that involves the traditional scalarization technique augmented with the dual of the preference function. This formulation is richer that the original scalarization technique as it allows to expose all elements of the Pareto front, as illustrated in FIGS. 11(A) and 11(B). In some embodiments, the server system 114 may use SciML learning technique known as “self-adaptive weights” and “Residual-based attention in physics-informed neural networks”, and automatic differentiation to compute Pareto optimal elements. The theory and the algorithms may be used later to connect to differential games.

### Differential Games and Numerical Exploration of Pareto Front

According to various aspects, the computing system 100 of the present disclosure may be configured to numerically explore Pareto fronts using solutions to differential games by creating an evolution for the Pareto optimal saddle-points that the server system 114 can efficiently compute. The connection to differential games arises when one observes that the saddle-point formulation actually corresponds to the two Hamiltonians associated with the viscosity solutions of a differential games with terminal cost when the dynamics are linear integrators. Furthermore, the Hamiltonian associated with the min-max saddle-point (the so-called “upper” solution) is concave and independent of the states of the differential game. Therefore, the viscosity solution can be efficiently evaluated in high-dimensions using the Hopf representation formula. For example, the server system 114 may be configured to perform a gradient descent on viscosity solutions, which yields a dynamic exposition of elements of the Pareto front. As a result, efficient MOO solvers may be obtained to explore the (non-convex) Pareto front of optimal solvers with mathematical guarantees.

For example, fix β>α≥0, q∈ [symbol] , t∈ [symbol] and consider the following differential equation:

$$\{ \begin{matrix}\dot{q} ( s ) = - p ( s ) & α < s < β \\ \dot{τ} ( s ) = t ( s ) & α < s < β \\ q ( α ) = q , & \\ τ ( α ) = τ , & \end{matrix}$$

where have used the same symbol for both the initial data and the map, which is a classical abuse of notations in differential game and optimal control problems. Now, consider the following cost functional

$${C}_{α , p , t} ( p ( ) , t ( ) ) = {\int }_{α}^{β} ( {\sum }_{i = 1}^{m} {t}_{i} ( s ) {H}_{i} ( p ( s ) ) - {g}^{*} ( t ( s ) ) + {R}^{*} ( p ( s ) ) ds ) + J ( q ( β ) , τ ( β ) ) ,$$

where R* is the Fenchel-Legendre transform of a continuous convex map R: [symbol] → [symbol] and J is also a convex continuous map. The quantify that appears inside the integral is the running cost while the map J corresponds to a terminal cost and g is a preference map. The server system 114 may interpret p( ) and t( ) as the strategy of two players that compete to respectively minimize of maximize the cost. The server system 114 may define the “lower value” map V and “upper value” map U as follows:

$$V ( ( q , τ ) , α ) = {min}_{p ( )} {max}_{t ( )} {C}_{α , p , t} ( p ( ) , t ( ) ) ,$$

$$U ( ( q , τ ) , α ) = {max}_{t ( )} {min}_{p ( )} {C}_{α , p , t} ( p ( ) , t ( ) ) .$$

The above two value functions may be the viscosity solution of the following Hamilton-Jacobi-Isaacs PDEs with terminal data

$$\{ \begin{matrix}\begin{matrix}\frac{\partial V}{\partial α} ( ( q , E ) , α ) + \\ {H}^{-} ( {∇}_{( q , E )} V ( ( q , E ) , α ) ) = 0\end{matrix} & \begin{matrix}0 \leq α < \\ β , q ∈ {ℝ}^{n} , E ∈ {ℝ}^{m}\end{matrix} \\ V ( ( q , E ) , β ) = J ( q , E ) & q ∈ {ℝ}^{n} , E ∈ {ℝ}^{m} ,\end{matrix} \qquad ( 6 )$$

$$and$$

$$\{ \begin{matrix}\begin{matrix}\frac{\partial U}{\partial α} ( ( q , E ) , α ) + \\ {H}^{+} ( {∇}_{( q , E )} V ( ( q , E ) , α ) ) = 0\end{matrix} & \begin{matrix}0 \leq α < \\ β , q ∈ {ℝ}^{n} , E ∈ {ℝ}^{m}\end{matrix} \\ U ( ( q , E ) , β ) = J ( q , E ) & q ∈ {ℝ}^{n} , E ∈ {ℝ}^{m}\end{matrix} \qquad ( 7 )$$

where the Hamiltonian H⁺(x, E) and H⁻(x, E) where x∈ [symbol] and E∈ [symbol] (Note that x can be interpreted as space while E is a collection of energies) are defined by:

$${H}^{+} ( x , E ) = {min}_{p ∈ {R}^{n}} {max}_{t ∈ {R}^{m}} 〈 x , - p 〉 + {\sum }_{i = 1}^{m} {t}_{i} {E}_{i} + {l}_{i} {H}_{i} ( p ( s ) ) - {g}^{*} ( t ) + {R}^{*} ( p ) ,$$

$${H}^{-} ( x , E ) = {max}_{t ∈ {R}^{m}} {min}_{p ∈ {R}^{n}} 〈 x , - p 〉 + {\sum }_{i = 1}^{m} {t}_{i} {E}_{i} + {t}_{i} {H}_{i} ( p ( s ) ) - {g}^{*} ( t ) + {R}^{*} ( p )$$

The server system 114 may perform computations to obtain the Hamiltonian H+ as follows:

$${H}^{+} ( x , E ) = {min}_{p ∈ {R}^{n}} 〈 x , - p 〉 + g ( H ( p ) + E ) + {R}^{*} ( p ) = - {( g ( H + E ) + R )}^{*} ( x )$$

which shows that this Hamiltonian is concave and independent of the state variable. The Hamiltonian may be a perturbation-regularization of the original min-max saddle point problem, and the objective functions H are additively perturbed by E while R* corresponds to a regularization/preference on the set of parameters of the meta-solver. Further, Hamiltonian can be numerically evaluated and the viscosity solution to (7) evaluated using the saddle point numerical solver and the Hopf-formula. A similar strategy may be developed for computing (6). Finally, a gradient descent may be performed on the value function to the differential to expose the Pareto front of optimal meta-solver.

In one aspect, the server system 114 may consider a nonlinear scalar PDE, e.g., ADR, and two systems of PDEs, e.g., the nonlinear elasticity and the Navier-Stokes equations. To validate the disclosed method, the server system 114 may be configured to rediscover the Newton-Rapson method and the FAS method and compare its GenAI generated implementation with available results reported in the literature and existent fast implementations in PETSc.

In yet another aspect, the server system 114 may analyze the computational complexities of the fastest new meta-solvers discovered and compare them with the computational complexity of the basic solvers from the silo used in their construction. For example, the server system 114 may can evaluate and compare the number of required iterations and the error/residual reduction to meet user-predefined tolerance for all discovered meta-solvers and conventional methods.

In addition, similar scalar equations and systems of equations in computational mechanics may be analyzed to discover novel nonlinear multilevel solvers. The server system 114 may apply unique optimization approach to exploit the (non-convex) Pareto front of meta-solvers, aiming to obtain a method that is significantly faster than the existing SOTA algorithms, such as those freely accessible within the PETSc library. The convergence and performance of the discovered nonlinear multilevel solvers may be assessed by comparing their convergence rate, as well as computational complexity, algorithmic scalability, parallelization capabilities, and memory requirements with conventional implementations of FAS and MG/OPT methods.

In some embodiments, the present disclosure may be used to solve a problem that involves waves, such as underwater acoustic waves, versus thermals of a semiconductor. A thermal problem is parabolic, which may be solved using a series of exponents, whereas waves may be solved with a Fourier expansion. The HINTS of the present disclosure may combine a FEM solver (Jacobi as an example) with a DeepONet. For example, the present disclosure may be used to combine Jacobi with a Fourier Neural Operator, it will work better than a DeepONet, because of the natural mathematical connection. That is, building a solver from different components brings better performance.

Moreover, the present disclosure relates to identifying the optimal parameters used to set up both the FEM solver as well as the ML solver that are being combined. Some parameters may be more suitable for the thermal problem and some parameters may be more suitable for the waves. The present disclosure customizes a solver given a task to yield better performance.

By using hybrid solvers, the present disclosure discloses creating use cases by selecting names from the silos. The silos may include Classical solvers, ML solvers and Strategies.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this present disclosure are described herein, including the best mode known to the inventors for carrying out the present disclosure. Of course, variations on these described embodiments will become apparent to those of ordinary skill in the art upon reading the foregoing description. The inventor expects skilled artisans to employ such variations as appropriate, and the inventors intend for the present disclosure to be practiced otherwise than specifically described herein. Accordingly, this present disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

Specific example embodiments disclosed herein may be further limited in the claims using consisting of or and consisting essentially of language. When used in the claims, whether as filed or added per amendment, the transition term “consisting of” excludes any element or step not specified in the claims. The transition term “consisting essentially of” limits the scope of a claim to the specified materials or steps and those that do not materially affect the basic and novel characteristic(s). Example embodiments of the present disclosure so claimed are inherently or expressly described and enabled herein.

In closing, it is to be understood that the embodiments of the present disclosure disclosed herein are illustrative of the principles of the present disclosure. Other modifications that may be employed are within the scope of the present disclosure. Thus, by way of example, but not of limitation, alternative configurations of the present disclosure may be utilized in accordance with the teachings herein. Accordingly, the present disclosure is not limited to that precisely as shown and described.

1. A computing server system deployed within a communication network, the computing server system comprising:
a non-transitory computer-readable storage medium storing machine readable instructions; and
a processor coupled to the non-transitory computer-readable storage medium and configured to execute the machine readable instructions to:
receive, from a computing device deployed within the communication network, a query to a large language model (LLM) for solving a problem;
formulate a differential equation in connection with the problem;
discretize the differential equation with a selected method;
select a plurality of combinations of neural operators and relaxation methods to form a Pareto front of viable solutions to the differential equation;
dynamically construct an array of meta-solvers based on the selected combinations of neural operators and relaxation methods;
identify a meta-solver from the array of meta-solvers to best solve the problem based on selected criteria;
use the meta-solver to generate problem solutions; and
display the problem solutions to the computing device.

2. The computing server system of claim 1, wherein the neural operators include at least one of a deep operator network, a Fourier neural operator, a Laplace neural operator, and a vision transformer operator.

3. The computing server system of claim 1, wherein the relaxation methods include at least one of a Jacobi method, a Gauss-Seidel method, a multigrid method, and a Chebyshev smoother.

4. The computing server system of claim 2, wherein the processor is further configured to execute the machine readable instructions to train the neural operators.

5. The computing server system of claim 4, wherein the processor is configured to execute the machine readable instructions to:
construct subspaces of a space in which the differential equation is solved by ensuring a locality and load balancing of each subspace; and
construct a coarse space to facilitate global information transfer.

6. The computing server system of claim 5, wherein the coarse space is constructed in an algebraic manner by utilizing near null-space vectors extracted from the neural operators that have been trained.

7. The computing server system of claim 6, wherein the processor is further configured to execute the machine readable instructions to select a subspace solve for each of the subspaces by at least alternating between a plurality of iterations of a standard iterative method to remove high-frequency components of error, and a neural operator inference to eliminate low-frequency components of the error.

8. The computing server system of claim 7, wherein the processor is further configured to execute the machine readable instructions to determine which stationary method to be hybridized with which neural operator, and determine a rate at which the neural operator is intertwined with the stationary method during a solution process.

9. The computing server system of claim 1, wherein the processor is further configured to execute the machine readable instructions to determine optimization techniques to identify an optimal solver using multi-objective optimization (MOO) techniques.

10. The computing server system of claim 9, wherein the processor is further configured to execute the machine readable instructions to:
implement derivative-free MOO solves to collect evaluation data of metrics associated with the Pareto front of the viable solutions to the differential equation; and
train surrogate models using the evaluation data to identify the meta-solver from the array of meta-solvers to best solve the differential equation.

11. The computing server system of claim 1, wherein the processor is further configured to execute the machine readable instructions to use a generative artificial intelligence method to generate codes of the meta-solvers.

12. The computing server system of claim 11, wherein the processor is further configured to execute the machine readable instructions to:
store codes of optimal meta-solvers for a plurality of problems on the non-transitory computer-readable storage medium; and
use a retrieval augment generation method to extract at least a portion of the codes in response to detecting that a received problem is similar to at least one the plurality of problems.

13. The computing server system of claim 1, wherein the processor is further configured to execute the machine readable instructions to use the neural operators to construct nonlinear preconditioner in connection with a Newton-Raphson method.

14. A computer-implemented method for identifying an optimal meta-solver via generative AI is carried out by a computing server system as claimed in claim 1.

15. A non-transitory computer-readable storage medium having instructions that, if executed by a processor of a computing server system, cause the computing server system to perform claim 1.

16. A computing system for dynamically constructing and selecting a meta-solver for solving a differential equation, the computing system comprising:
one or more processors; and
one or more non-transitory computer-readable storage media storing instructions that, when executed by the one or more processors, cause the one or more processors to:
(a) receive input data specifying a differential equation to be solved, including at least one of a differential operator, boundary conditions, coefficient data, or source terms,
(b) identify a plurality of candidate neural operators, each neural operator being configured to generate a correction to a numerical solution based on residual data associated with an iterative solution process,
(c) identify a plurality of candidate relaxation methods, each relaxation method comprising an iterative numerical solver configured to reduce error components of a discretized system associated with the differential equation,
(d) dynamically construct an array of meta-solvers, wherein each meta-solver in the array comprises:
a selected neural operator from the plurality of candidate neural operators,
a selected relaxation method from the plurality of candidate relaxation methods, and
an execution schedule defining an alternating application of the selected neural operator and the selected relaxation method during execution of an iterative solver,
(e) evaluate each meta-solver in the array by executing at least a portion of the iterative solver using the execution schedule and computing one or more performance metrics including at least one of convergence behavior, numerical stability, computational cost, or scalability,
(f) select an optimal meta-solver from the array of meta-solvers based on a multi-objective optimization over the one or more performance metrics, and
(g) apply the selected optimal meta-solver to iteratively solve the differential equation by alternating between neural-operator-based correction steps and relaxation-based numerical solver steps until a convergence criterion is satisfied.

17. The computing system of claim 16, wherein the execution schedule defines a fixed or adaptive ratio of neural-operator-based correction steps to relaxation-based numerical solver steps, and wherein the selected neural operator is invoked intermittently to reduce low-frequency error components that slow convergence of the selected relaxation method.

18. The computing system of claim 16, wherein each meta-solver is configured to operate on residual data generated during execution of the iterative solver, and wherein the selected neural operator receives a function-form or discretized representation of the residual data and produces a correction applied to an approximate numerical solution.

19. The computing system of claim 16, wherein at least one meta-solver in the array is configured as a preconditioner for a Krylov subspace method or a multilevel solver, such that the alternating application of the selected neural operator and relaxation method accelerates convergence of the Krylov subspace method or the multilevel solver.

20. The computing system of claim 16, wherein dynamically constructing the array of meta-solvers comprises generating multiple solver configurations that differ in at least one of:
(a) a neural-operator architecture;
(b) the selected relaxation method; or
(c) the execution schedule defining when the selected neural operator is invoked during the iterative solution process.
